(19) United States
(12) Patent Application Publication
(10) Pub. No.: US 2016/0049042 A1
(43) Pub. Date: Feb. 18, 2016

(54) SYSTEMS AND METHODS FOR GENERATING A BLENDED SYMBOL BASED ON DATA DISPLAYED IN A USER INTERFACE OF A GAME

(71) Applicant: Gamesys Ltd., London (GB)

(72) Inventors: Hans Elias, Hertfordshire (GB); Alexander Sandford Todd Young, London (GB); Toby Street, London (GB)

(21) Appl. No.: 14/925,249

(22) Filed: Oct. 28, 2015

Related U.S. Application Data
(63) Continuation of application No. PCT/US15/26551, filed on Apr. 17, 2015.
(60) Provisional application No. 61/981,791, filed on Apr. 19, 2014.

(51) Int. Cl. G07F 17/32; G07F 17/34; A63F 9/24

(52) U.S. Cl. CPC G07F 17/3213; A63F 9/24; G07F 17/34; A63F 2009/2457

(57) ABSTRACT

In accordance with some embodiments, a game or gaming system provides a game which includes a plurality of regular symbols being placed in symbol positions (e.g., on reels of a reel-type slot machine game) and identifying that a first regular symbol of the plurality of regular symbols is to be designated as a first blended symbol in determining a result of a game event, wherein a blended symbol comprises a symbol which functions as (e.g., is substitutable for) at least two regular symbols of the game in determining results for game events of the game, the at least two regular symbols which the blended symbol functions as being determined based on the plurality of regular symbols determined for the game event in which the blended symbol is to be applied.

### CLAIM OF PRIORITY

This application is a Continuation application of PCT Application PCT/US15/026551 filed on Apr. 17, 2015 in the name of Elias et al. and titled SYSTEMS AND METHODS FOR FACILITATING USE OF A BLENDED SYMBOL IN A GAME, which PCT Application claims the benefit of U.S. Provisional Application No. 61/981,791 filed on Apr. 19, 2014 in the name of Elias et al., titled SYSTEMS AND METHODS FOR FACILITATING USE OF A BLENDED SYMBOL IN A GAME. The entirety of each of these applications is incorporated by reference herein for all purposes.

### BRIEF DESCRIPTION OF THE FIGURES

FIG. 1 is a schematic diagram of an embodiment of a gaming system in accordance with one or more embodiments described herein.

FIG. 2 is a schematic diagram of an embodiment of a social gaming platform in accordance with one or more embodiments described herein.

FIG. 3 is a block diagram of an embodiment of a computing device useful in a system according to one or more embodiments described herein.

FIG. 4 is a flowchart of an example process consistent with one or more embodiments described herein.

FIG. 5 is a flowchart of an example process consistent with one or more embodiments described herein.

FIGS. 6A-6C comprise one example embodiment of a grid of symbol positions which may comprise a component of a game interface which utilizes blended symbols in accordance with some embodiments described herein, illustrating one manner of populating the symbol positions and determining a blended symbol.

FIGS. 7A-7C comprise one example embodiment of a grid of symbol positions which may comprise a component of a game interface which utilizes blended symbols in accordance with some embodiments described herein, illustrating one manner of indicating which subset of regular symbols a blended symbol functions as.

FIGS. 8A-8C comprise one example embodiment of a grid of symbol positions which may comprise a component of a game interface which utilizes blended symbols in accordance with some embodiments described herein, illustrating an expanding area of effect for a blended symbol.

### DETAILED DESCRIPTION OF EXAMPLE EMBODIMENTS

### I. Introduction

Systems, methods and articles of manufacture (e.g., non-transitory computer-readable media) provide for facilitating a game comprising a plurality of symbols, wherein certain combinations of such symbols when arranged in a predetermined configuration (e.g., along a payline) result in a prize being awarded to a player, and further wherein one or more of the symbols may be designated a Blended Symbol (e.g., if it appears in a designated Blended Symbol position of the game interface). A Blended Symbol, in accordance with some embodiments, is a symbol which functions as (e.g., is substitutable for) one or more of a plurality of symbols (e.g., the plurality being a subset of the symbols available in the game and, in some embodiments, a subset of the symbols determined for a particular game event). In one embodiment, the symbols for which a Blended Symbol functions as is determined dynamically for each game event (e.g., for each spin of a reeled slot machine type game). In one example embodiment, a given Blended Symbol is dynamically determined to function as any other symbol in an area of effect corresponding to the Blended Symbol. A Blended Symbol may “function as” a symbol by being treated, for purposes of determining a result of the game event, as that symbol. A Blended Symbol functioning as one or more of a plurality of symbols means the symbol may be recognized, depending on the particular embodiment, as any or all of the plurality of symbols. Thus, for example, if a symbol “A” is determined to be a Blended Symbol for a particular game event and it is determined that this Blended Symbol is to “function as” symbol “A” and also as symbol “B”, this may mean that when the system is evaluating active paylines to determine a result for the game event, it evaluates each such payline along with the Blended Symbol appears by treating it, for purposes of determining whether the outcome of the payline is a winning outcome, as (i) either “A” or “B” or (ii) a combination of “A” and “B”.

It should be understood that a Blended Symbol need not necessarily function as two or more different types of symbols. In some embodiments, two or more of the same type of symbol may be blended and thus a Blended Symbol may function as two or more instances of the same type of symbol. Thus, for example, if a symbol “A” were determined to be a Blended Symbol and it is determined that this Blended Symbol is to function as “A-A” (meaning two (2) “A” symbols) then, when the system is evaluating active paylines to determine a result for the game event, it may determine (for each active payline along which the Blended Symbol Appears) that the payline includes two A symbols for each such Blended Symbol. Before describing further embodiments, some background on games and gaming is provided.

Games, whether wagering or non-wagering, are a popular past-time for millions of people all over the world. Electronic games in particular are becoming more and more popular, particularly ones playable online using a computer connected to a network. For example, according to some reports more than 200 million people play social games every month and online games recently passed e-mail as the second-most popular activity online, second only behind social networking. Accordingly, there is a need to continue to create exciting electronic games which maintain players' interest and stand out from the multitude of available online games.

Various “reel-type” or reeled slot machine games are popular with many players, whether deployed on dedicated gaming devices (e.g., a traditional slot machine device in a casino, operable primarily to facilitate one or more slot machine games) or on non-dedicated computing devices (e.g., personal computers, mobile devices, laptops or table computers, which are operable to perform a variety of functions in addition to supporting reeled slot machine games). A reeled slot machine game typically includes a plurality of reels, each reel including a plurality of symbol positions for display of a reel symbol. A symbol is a visual representation of an element or indicia used in the game to determine whether the player qualifies for an award. A reel symbol is a symbol output on a reel of a game interface. The term “symbol” as used herein may refer to a reeled symbol or a symbol of another type of game that is not a reel-type slot machine game (e.g., a game consisting of a grid, such as a bingo game, or any other type of interface that may be applied to embodiments described herein). A reel may be mechanical (e.g., in a physical dedicated gaming device on a casino floor) or virtual (e.g., a software representation of a reel on an electronic display of a dedicated or non-dedicated device). In a reel-type slot machine game the reels spin (or representations of virtual reels are made to look as if they spin) after a player places a wager on the game, provides another qualifying input or another reel-initiation event occurs. The reels then stop to display generated combinations of symbols on the reels.

It should be noted that embodiments described herein are not limited to reel-type slot machine games. For example, the embodiments may be implemented in a card game (e.g., a multi-hand video poker game), a grid type game (e.g., a bingo game) or any type of game in which representations of outcomes are output in a configuration which lends itself to the blended symbol game mechanic described herein. Thus, it should be noted that although the term “spin” is used to refer to a game event which results in an outcome, the term “spin” is intended to encompass any type of game event (not limited to a game event in a reel-type slot machine game) for which an outcome may be determined.

The “outcome” of a spin or other type of game event, as the term is used herein, is the set of symbols as displayed in a set of symbol positions which are evaluated to determine whether the spin results in an award or prize. In a reel-type slot machine game, an outcome of a spin may refer to the symbols displayed along symbol positions comprising one or more paylines of the game. If a generated symbol or combination of symbols is a winning symbol or combination of symbols (i.e., a symbol or combination of symbols associated with an award), the award corresponding to the winning symbol or winning symbol combination is provided or output (e.g., if the generated winning symbol or winning combination of symbols appears along an active payline associated with the reels or in a scatter pay of a reel-type slot machine game). The symbols along a payline at the end of a spin (i.e., once the reels are stopped and the symbols in the symbol positions are positioned such that a player may determine whether he/she qualifies for an award as a result of the spin) are referred to as the “outcome of the payline” herein. Thus, an outcome of a spin may comprise one or more outcomes of paylines.

An outcome of a payline may include a winning combination of symbols along with one or more additional symbols. For example, in a five (5) reel slot machine game, a payline may include five (5) symbol positions (e.g., one symbol position in each reel of the 5 (five) reels). However, one or more possible winning combinations of symbols may comprise three (3) or four (4) symbol combinations such that an occurrence of a winning combination of symbols along the payline will include the symbols comprising the winning combination as well as additional symbols that, while not part of the winning combination of symbols, are also along the payline and thus included in the outcome of the payline. For example, assume an occurrence of three (3) cherry symbols along a payline in a fruit-themed five (5) reel slot machine type game corresponds to an award of two (2) credits and an outcome of a spin includes the following symbols in the symbol positions comprising that payline: cherry-cherry-lemon-orange-cherry. In accordance with rules of one particular example game, the award corresponding to the three cherry symbols along the payline may be awarded to the player and the three cherry symbols may be referred to as the winning combination of symbols while the lemon and orange symbols are not part of the winning combination of symbols but are still part of the outcome of the payline.

One game feature available in some reeled games is the use of one or more wild symbols in some particular manners. A wild symbol is a symbol which may be placed in a symbol position of a reel and which substitutes for, replaces or functions as one of the regular symbols on one of the reels (e.g., a wild symbol may be treated as equivalent to any of the regular symbols of the game). Use of a wild symbol in a game enables, for example, changing of a first or non-winning combination of symbols to a second and possibly winning combination of symbols (e.g., to make a winning combination or align a winning combination on an active payline) by replacing a regular symbol with a wild symbol in order to create a winning combination of symbols, thus increasing additional opportunities for winning combinations. Applicants have recognized that there is a continuing need for new ways of utilizing wild symbols in a reeled slot machine game to create added excitement and reward opportunities within the game. Applicants have further recognized that although wild symbols are popular with players, the frequency with which they may be offered is limited as wild symbols add a large amount to the Return to Player (RTP) or payback percentage of the game (an unacceptably high RTP makes a game unattractive to the gaming entity which offers the game because it undermines the profitability of the game).

Applicants have describe herein a novel type of symbol comprising a novel type of functionality. Referred to as a Blended Symbol herein, this novel type of symbol comprise a symbol which is substitutable for a subset of the regular symbols available in the game (as opposed to a wild symbol, which is substitutable for all the regular symbols available in the game). A Blended Symbol need not correspond to any particular graphic, icon, visual, audio or other depiction. Rather a Blended Symbol is a symbol characterized by the functionality of functioning as a plurality of other symbols. While the other symbols the Blended Symbol may function as are referred to herein as “regular symbols” this terminology is intended merely to distinguish the symbols from the Blended Symbol. The symbols a Blended Symbol functions as may be other special symbols in a game (e.g., multiplier symbols, special character symbols which contribute to a bonus or other progress in a game, etc.) and the term “regular symbols” should not be construed as being limited to any particular type of symbol, other than it not being a Blended Symbol. In some embodiments, the plurality of regular symbols a Blended Symbol functions as comprises a subset of symbols available in the game. In some embodiments, the symbols for which a Blended Symbol is substitutable for is predetermined. However, in other embodiments, the determination of which symbols a Blended Symbol is substitutable for is a dynamic determination which occurs during a game (e.g., for each individual spin or game event or for a plurality of spins or game events but not for all spins or game events of the game). Thus, for example, if the symbols A, B, C, D and E comprise the complete set of regular symbols available in a game, in accordance with some embodiments a Blended Symbol appearing as part of an outcome for a first spin may function as (e.g., be substitutable for) symbols A, B or D while a Blended Symbol appearing as part of an outcome for a second spin may function as (e.g., be substitutable for) a different subset of symbols (e.g., symbols B, C and E). In accordance with some embodiments, the regular symbols of a game for which a Blended Symbol is substitutable for or otherwise functions as may be determined based on the set of regular symbols determined as an outcome (or preliminary outcome) for a game event (e.g., the set of symbols to appear in a portion of a game interface visible to a player upon an initial resolution of a game event, such as when the reels stop spinning or are made to appear to stop spinning in a virtual reel game, or the symbols otherwise placed in symbol positions of a game interface of the game for a particular game event)

In one embodiment, a plurality of Blended Symbols may comprise an outcome of a spin and the subset of symbols each respective Blended Symbol is substitutable for may be determined dynamically and thus may be different for each such Blended Symbol. For example, the subset of regular symbols for which a particular Blended Symbol is substitutable for may be determined based on one or more other symbols comprising an outcome of which the Blended Symbol is a part of.

In accordance with some embodiments, a Blended Symbol comprises a regular symbol of a game which becomes designated, based on a qualifying event or rule of the game, to take on the blending functionality and thus become a Blended Symbol for the current game event (and, in some embodiments, for one or more subsequent game events). For example, a regular symbol may become designated as a Blended Symbol if it is placed in a symbol position associated with Blended Symbol functionality (whether this is position is persistently (e.g., from one spin to another) so associated with Blended Symbol functionality or is determined or selected to be associated with Blended Symbol functionality for purposes of at least one particular game event). In another example, a regular symbol may become designated as a Blended Symbol by being selected as a Blended Symbol based on a random or pseudo-random algorithm. In yet another example, a regular symbol may become designated as a Blended Symbol because it is placed near or positionally arranged within a game interface relative to another symbol or type of symbol in a predetermined configuration or arrangement which satisfies a rule of the game. For example, in one embodiment if a predetermined number (e.g., three (3)) of the same type of regular symbol are placed in a row, column or other predetermined positional relationship relative to one another (which positional relationship need not be a contiguous one), one or more of the regular symbols so positioned may be designated as a Blended Symbol. In yet another example, a regular symbol may be designated as a Blended Symbol based on a selection, preference or input from a player (e.g., a player may select a particular regular symbol to be a Blended Symbol for a game). In any of the aforementioned example methodologies for designating a regular symbol as a Blended Symbol, it should be noted that (i) the subset of regular symbols for which the Blended Symbol is substitutable may either be predetermined or determined dynamically in any of the various manners described herein; and (ii) such designation may be for a single game event or persist over a plurality of game events or sub-events (e.g., for a plurality of cascades based on an original spin).

In one embodiment, the regular symbols which the Blended Symbol functions as (e.g., is substitutable for) comprises the regular symbol which became a Blended Symbol plus any other regular symbol within an area of effect corresponding to the Blended Symbol (e.g., irrespective of whether these regular symbols are the same or different from the regular symbol which has been designated as a Blended Symbol). An area of effect, as the term is used herein unless specified otherwise, comprises an area within a game interface (e.g., the area comprising a plurality of symbol positions) within which at least one game symbol is output and which has been designated as the area to be used for determining the symbols a Blended Symbol is substitutable for. For example, an area of effect may be determined to be a plurality of individual symbol positions and the regular symbols of the game which appear in these individual symbol positions are the regular symbols which a Blended Symbol corresponding to the area of effect functions as (e.g., is substitutable for). In one embodiment, the symbol position within which the game symbol designated to be a Blended Symbol appears in is considered to be part of the area of effect such that that Blended Symbol is substitutable for at least the regular symbol which appears in that symbol position. In some embodiments, the symbol positions comprising the area of effect are adjacent to or contiguous with one another while in other embodiments they are not (e.g., the area of effect may comprise symbol positions scattered throughout the game interface).

In accordance with one embodiment, a regular symbol is designated as a Blended Symbol for an outcome if it appears in a designated symbol position (e.g., at the resolution of a game event such as once the reels of a reel type slot machine game come to a stop). In many games, a game interface for outputting an outcome comprises a plurality of symbol positions (e.g., each reel of a reel type slot machine game comprises a plurality of symbol positions, each card position in a card game comprises a symbol position, each cell in a grid-type interface comprises a symbol position, etc.). In accordance with some embodiments, at least one of such symbol positions of the interface may be designated as a “Blended Symbol” position such that any game symbol which appears (e.g., at the resolution of an outcome or other game event) in this position is considered to be a Blended Symbol and thus has attributed to it the functionality of a Blended Symbol (e.g., the symbol appearing in the Blended Symbol position becomes substitutable for a subset of the regular symbols available in the game, the subset being greater than one (1), such as the symbols appearing within an area of effect corresponding to the Blended Symbol position).

Certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

Although several embodiments, examples and illustrations are described herein, it will be understood by those of ordinary skill in the art that the invention described herein extends beyond the specifically disclosed embodiments, examples and illustrations and includes other uses of the invention and obvious modifications and equivalents thereof. Embodiments of the invention(s) are described with reference to the accompanying figures, wherein like numerals refer to like elements throughout. The terminology used in the description presented herein is not intended to be interpreted in any limited or restrictive manner simply because it is being used in conjunction with a detailed description of certain specific embodiments of the invention(s). In addition, embodiments of the invention(s) can comprise several novel features and it is possible that no single feature is solely responsible for its desirable attributes or is essential to practicing the invention(s) herein described.

Throughout the description that follows and unless otherwise specified, the following terms may include and/or encompass the example meanings provided in this section. These terms and illustrative example meanings are provided to clarify the language selected to describe embodiments both in the specification and in the appended claims, and accordingly, are not intended to be limiting. Other terms are defined throughout the present description.

A “game”, as the term is used herein unless specified otherwise, may comprise any game (e.g., wagering or non-wagering, electronically playable over a network) playable by one or more players in accordance with specified rules. A game may be playable on a personal computer online in web browsers, on a game console and/or on a mobile device such as a smart-phone or tablet computer. A game may also be playable on a dedicated gaming device (e.g., a slot machine in a brick-and-mortar casino). “Gaming” thus refers to play of a game.

A “casual game”, as the term is used herein unless specified otherwise, may comprise a game with simple rules with little or no time commitment on the time of a player to play. A casual game may feature, for example, very simple game play such as a puzzle or Scrabble™ game, may allow for short bursts of play (e.g., during work breaks), an ability to quickly reach a final stage and/or continuous play without a need to save the game.

A “social network game”, as used herein unless specified otherwise, refers to a type of online game that is played through a social network, and in some embodiments may feature multiplayer and asynchronous game play mechanics. A “social network” may refer to an online service, online community, platform, or site that focuses on facilitating the building of social networks or social relations among people. A social network service may, for example, consist of a representation of each user (often a profile), his/her social links, and a variety of additional services. A social network may be web-based and provide means for users to interact over the Internet, such as e-mail and instant messaging. A social network game may in some embodiments be implemented as a browser game, but can also be implemented on other platforms such as mobile devices.

A “wagering game”, as the term is used herein, may comprise a game on which a player can risk a wager or other consideration, such as, but not limited to: slot games, poker games, blackjack, baccarat, craps, roulette, lottery, bingo, keno, casino war, etc. A wager may comprise a monetary wager in the form of an amount of currency or any other tangible or intangible article having some value which may be risked on an outcome of a wagering game. “Gambling” or “wagering” refers to play of a wagering game.

The term “game provider”, as used herein unless specified otherwise, refers to an entity or system of components which provides, or facilitates the provision of, games for play and/or facilitates play of such game by use of a network such as the Internet or a proprietary or closed networks (e.g., an intranet or wide area network). For example, a game provider may operate a website which provides games in a digital format over the Internet. In some embodiments in which a game comprising a wagering game is provided, a game provider may operate or facilitate a gambling website over which wagers are accepted and results of wagering games are provided.

The terms “information” and “data”, as used herein unless specified otherwise, may be used interchangeably and may refer to any data, text, voice, video, image, message, bit, packet, pulse, tone, waveform, and/or other type or configuration of signal and/or information. Information may comprise information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encoded, encrypted, and/or otherwise packaged or manipulated in accordance with any method that is or becomes known or practicable.

The term “indication”, as used herein unless specified otherwise, may refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

The term “network component,” as used herein unless specified otherwise, may refer to a user or network device, or a component, piece, portion, or combination of user or network devices. Examples of network components may include a Static Random Access Memory (SRAM) device or module, a network processor, and a network communication path, connection, port, or cable.

In addition, some embodiments are associated with a “network” or a “communication network”. As used herein, the terms “network” and “communication network” may be used interchangeably and may refer to any object, entity, component, device, and/or any combination thereof that permits, facilitates, and/or otherwise contributes to or is associated with the transmission of messages, packets, signals, and/or other forms of information between and/or within one or more network devices. Networks may be or include a plurality of interconnected network devices. In some embodiments, networks may be hard-wired, wireless, virtual, neural, and/or any other configuration of type that is or becomes known. Communication networks may include, for example, one or more networks configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard or protocol that is or becomes known or practicable.

The term “player,” as used herein unless specified otherwise, may refer to any type, quantity, and or manner of entity associated with the play of a game. In some embodiments, a player may comprise an entity (i) conducting play of an online game, (ii) that desires to play a game (e.g., an entity registered and/or scheduled to play and/or an entity having expressed interest in the play of the game—e.g., a spectator) and/or may (iii) that configures, manages, and/or conducts a game. A player may be currently playing a game or have previously played the game, or may not yet have initiated play—i.e., a “player” may comprise a “potential player” (e.g., in general and/or with respect to a specific game). In some embodiments, a player may comprise a user of an interface (e.g., whether or not such a player participates in a game or seeks to participate in the game).

Some embodiments described herein are associated with a “player device” or a “network device”. As used herein, a “player device” is a subset of a “network device”. The “network device”, for example, may generally refer to any device that can communicate via a network, while the “player device” may comprise a network device that is owned and/or operated by or otherwise associated with a player. Examples of player and/or network devices may include, but are not limited to: a Personal Computer (PC), a computer workstation, a computer server, a printer, a scanner, a facsimile machine, a copier, a Personal Digital Assistant (PDA), a storage device (e.g., a disk drive), a hub, a router, a switch, and a modem, a video game console, or a wireless or cellular telephone. Player and/or network devices may, in some embodiments, comprise one or more network components.

A “session” comprises a period of time spanning a plurality of event instances, game instances, spins or turns of a game, the session having a defined start and defined end. An “event instance”, “game instance”, “session” or “turn” is triggered upon an initiation of, or request for, at least one result of the game by a player, such as an actuation of a “start” or “spin” mechanism, which initiation causes an outcome to be determined or generated (e.g., a random number generator is contacted or communicated with to identify, generate or determine a random number to be used to determine a result for the event instance). An event instance or turn may comprise an event instance or turn of a primary game or an event instance or turn of a bonus round, mode or feature of the game. Accordingly, a session may refer to a session of a primary game or a session of a bonus round, mode or feature of the game, depending on the context.

An “outcome” should be differentiated from a “result” in the present description in that an “outcome” is a representation of a “result”, typically comprising one or more game elements or game symbols. For example, in a “fruit themed” game, a winning outcome (i.e., an outcome corresponding to some kind of award, prize or payout) may comprise a combination of three “cherry” symbols. The “result” of this outcome may be a payout of X credits awarded to the player associated with the game. In another example, in a game in which a character moves along a game interface from a starting position to a finish position, an “outcome” of the game may comprise a symbol representing one or more movements along the interface and the “result” corresponding to this outcome may be the particular number and direction of the character's movement (e.g., three spaces backwards such that the character ends up further away from the finish line). In a session embodiment, a session result may comprise a binary result (e.g., a player or game character wins or loses the session) and/or the particular award (or magnitude of award) won or earned by the player based on the session (e.g., the number of credits awarded to the player). It should be noted that the embodiments described herein encompass prizes which may comprise awards, payouts, discounts, eligibility, advancement in a game or other benefits (whether monetary or non-monetary, tangible or intangible) to a player and that any reference to a “prize”, “award” or “payout” may refer to any or all of the foregoing, unless the context explicitly indicates otherwise.

A “bonus round”, “bonus mode” or “bonus feature” of a game, as the terms are used interchangeably herein unless indicated otherwise, may refer to a secondary game, entry into which is triggered via one or more events which may occur in a base or primary game. Typically, a player may be able to qualify to play a bonus game based on one or more outcomes in a primary game, such as in a basic mode or a qualifying mode. A bonus round may be played in accordance with a set of rules that is different from those of a primary game, and may be accompanied by displays, colors, sounds, animated sequences, game play and/or prizes that are not part of the primary game. In one embodiment, a primary or base game application or program may include programming or instructions which will automatically begin a bonus round after the player has achieved a triggering event or qualifying condition in the base or primary game.

“Virtual currency” as the term is used herein unless indicated otherwise, refers to an in-game currency that may be used as part of a game or one or more games provided by a game provider as (i) currency for making wagers, and/or (ii) to purchase or access various in-game items, features or powers. References to an “award”, “prize” and/or “payout” herein are intended to encompass such in the form of virtual currency, credits, real currency or any other form of value, tangible or intangible.

A “credit balance”, as the term is used herein unless indicated otherwise, refers to (i) a balance of currency, whether virtual currency or real currency, usable for making wagers or purchases in the game (or relevant to the game), and/or (ii) another tracking mechanism for tracking a player's success or advancement in a game by deducting therefrom points or value for unsuccessful attempts at advancement and adding thereto points or value for successful attempts at advancement. A credit balance may be increased or replenished with funds external to the game. For example, a player may transfer funds to the credit balance from a financial account or a gaming establishment may add funds to the credit balance due to a promotion, award or gift to the player.

### II. Description of Figures

### Example Systems

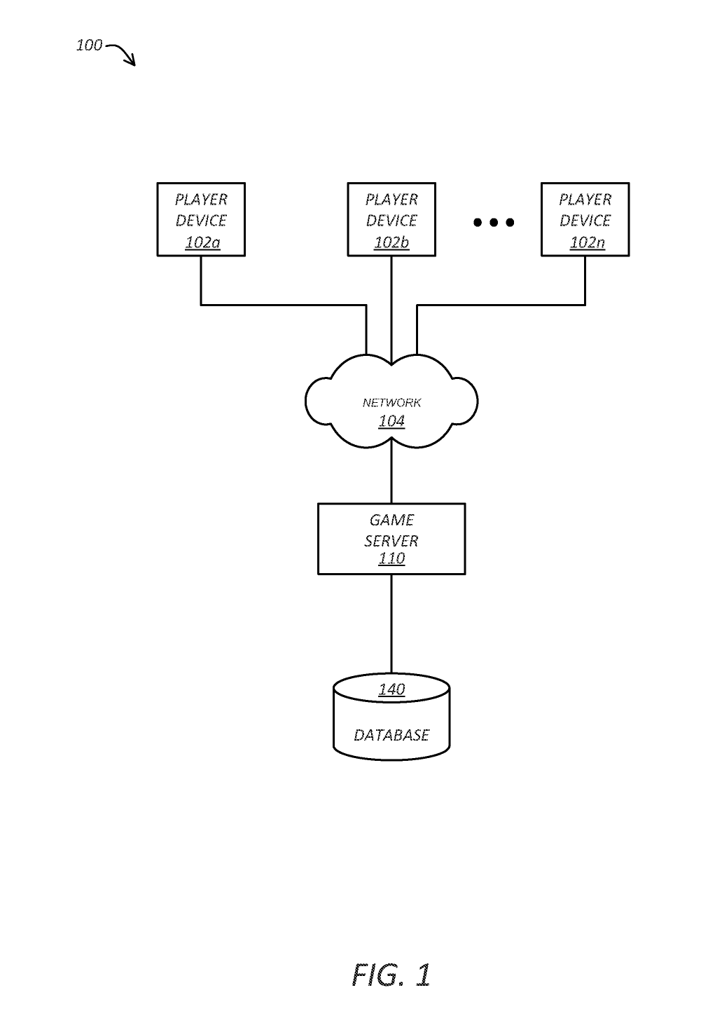

Referring now to the figures, FIG. 1 depicts a block diagram of an example system 100 according to some embodiments. The system 100 may comprise a plurality of player devices 102a-102n in communication with a game server 110 via a network 104. For purposes of brevity, any or all of the player devices 102a-102n will be referred to as a player device 102 herein, even though the plurality of player devices 102a-102n may include different types of player devices (as described below). The game server 110 may also be operable to communicate with or access a database 140 (which may comprise one or more databases and/or tables and which may comprise a storage device distinct from (or be a component of) the game server 110). It should be noted that in some embodiments database 140 may be stored on a game server 110 while in other embodiments database 140 may be stored on another computing device with which game server 110 is operable to communicate in order to at least access the data in database 140 (e.g., another server device remote from game server 140, operable to determine outcomes for an event instance of a game). In some embodiments a processor (e.g., one or more microprocessors, one or more microcontrollers, one or more digital signal processors) of a player device 102 and/or game server 110 may receive instructions (e.g., from a memory or like device), and execute those instructions, thereby performing one or more processes defined by those instructions. Instructions may be embodied in, e.g., one or more computer programs and/or one or more scripts.

In some embodiments a game server 110 and/or one or more of the player devices 102 stores and/or has access to data useful for facilitating play of a game. For example, game server 110 and/or a player device 102 may store (i) one or more probability databases for determining one or more outcome(s) for an event instance, spin or turn of a game, (ii) a current state or status of a game or game session (e.g., an indication of one or more Blended Symbols currently active in the game and which regular symbol(s) each such Blended Symbol is currently substitutable for), (iii) one or more user interfaces for use in a game, (iv) one or more game themes for a game and/or (v) profiles or other personal information associated with a player of a game. It should be noted that in some embodiments such data may be stored on the game server 110 and information based on such data may be output to a player device 102 during play of a game while in other embodiments a game program may be downloaded to a local memory of a player device 102 and thus such data may be stored on a player device 102 (e.g., in encrypted or other secure or tamper-resistant form).

A game server 110 may comprise a computing device for facilitating play of a game (e.g., by receiving an input from a player, determining an outcome for a game, causing an outcome of a game to be displayed on a player device, determining whether to substitute or output a Blended Symbol at a particular symbol position of a game interface, facilitating a wager and/or a provision of a payout for a game). For example, the game server 110 may comprise a server computer operated by a game provider or another entity (e.g., a social network website not primarily directed at providing games). In some embodiments, the game server may determine an outcome for spin of a game by requesting and receiving such an outcome from another remote server operable to provide such outcomes. In some embodiments, the game server 110 may further be operable to facilitate a game program for a game (e.g., a wagering game).

In accordance with some embodiments, in addition to administering or facilitating play of a game, a game server 110 may comprise one or more computing devices responsible for handling online processes such as, but not limited to: serving a website comprising one or more games to a player device and/or processing transactions (e.g., wagers, deposits into financial accounts, managing accounts, controlling games, etc.). In some embodiments, game server 110 may comprise two or more server computers operated by the same entity (e.g., one server being primarily for storing states of games in progress and another server being primarily for storing mechanisms for determining outcomes of games, such as a random number generator). Examples of processes that may be performed by the game server 110 (directly or indirectly) may include, but are not limited to: (i) determining an initial outcome (i.e., an outcome prior to any replacing or cascading of symbols) for a player; (ii) determining whether the outcome causes a Blended Symbol to be activated in the game; (iii) determining an area of effect for a particular Blended Symbol; (iv) determining (e.g., based on the corresponding area of effect) which regular game symbols a particular Blended Symbol is substitutable for; (v) re-evaluating one or more paylines of the game for any additional winning combinations created as a result of any Blended Symbols and the symbols they are respectively substitutable for; (vi) transmitting an indication of outcomes to a player device; (vii) authorizing a game program to be downloaded to a player device; and/or (viii) modifying (or directing a player device to modify) a game interface which is outputting an outcome of a payline to reflect any cascading and/or substituting of symbols as a result of the creation of Blended Symbols or other features of the game.

Turning now to a description of a player device 102, in accordance with some embodiments a player device 102 may comprise a computing device that is operable to execute or facilitate the execution of a game program and used or useful by an online player for accessing an online casino or other electronic (e.g., online) game provider. For example, a player device 102 may comprise a desktop computer, computer workstation, laptop, mobile device, tablet computer, Personal Digital Assistant (PDA) devices, cellular or other wireless telephones (e.g., the Apple™ iPhone™), video game consoles (e.g., Microsoft™ Xbox 360™, Sony™ Plasystation™, and/or Nintendo™ Wii™), and/or handheld or portable video game devices (e.g., Nintendo™ Game Boy™ or Nintendo™ DS™). A player device 102 may comprise and/or interface with various components such as input and output devices (each of which is described in detail elsewhere herein) and, in some embodiments, game server 110. A player device 102 may be a dedicated gaming device (e.g., a slot machine) or a non-dedicated gaming device (e.g., an iPad™). It should be noted that a game server 110 may be in communication with a variety of different types of player devices 102.

A player device 102 may be used to play a wagering or non-wagering game (e.g., a social or casual game) over a network and output information relating to the game to players participating in the game (e.g., outcomes for an event instance of the game, qualifying for a bonus round of the game, credit balance of credits available for play of the game, a session result for a session of the game, etc.). Any and all information relevant to any of the aforementioned functions may be stored locally on one or more of the player devices 102 and/or may be accessed using one or more of the player devices 102 (in one embodiments such information being stored on, or provided via, the game server 110). In another embodiment, a player device 102 may store some or all of the program instructions for determining, for example, (i) that an event instance has been triggered or initiated (and, in some embodiments, communicating such a trigger or initiation to game server 110), (ii) one or more outcomes of the game; (iii) one or more results of the game and/or (iv) determining a session result. In some embodiments, the game server 110 may be operable to authorize the one or more player devices 102 to access such information and/or program instructions remotely via the network 104 and/or download from the game server 110 (e.g., directly or via an intermediary server such as a web server) some or all of the program code for executing one or more of the various functions described in this disclosure. In other embodiments, outcome and result determinations may be carried out by the game server 110 (or another server with which the game server 110 communicates) and the player devices 102 may be terminals for displaying to an associated player such outcomes and results and other graphics and data related to a game.

It should be noted that the one or more player devices 102 may each be located at the same location as at least one other player device 102 (e.g., such as in a casino or internet café) or remote from all other player devices 102. Similarly, any given player device may be located at the same location as the game server 110 or may be remote from the game server 110. It should further be noted that while the game server 110 may be useful or used by any of the player devices 102 to perform certain functions described herein, the game server 110 need not control any of the player devices 102. For example, in one embodiment the game server 110 may comprise a server hosting a website of an online casino accessed by one or more of the player devices 102.

In one embodiment, a game server 110 may not be necessary or desirable. For example, some embodiments described in this disclosure may be practiced on one or more player devices 102 without a central authority. In such an embodiment, any functions described herein as performed by a game server 110 and/or data described as stored on a game server 110 may instead be performed by or stored on one or more player devices 102. Additional ways of distributing information and program instructions among one or more player devices 102, a game server 110 and/or another server device will be readily understood by one skilled in the art upon contemplation of the present disclosure.

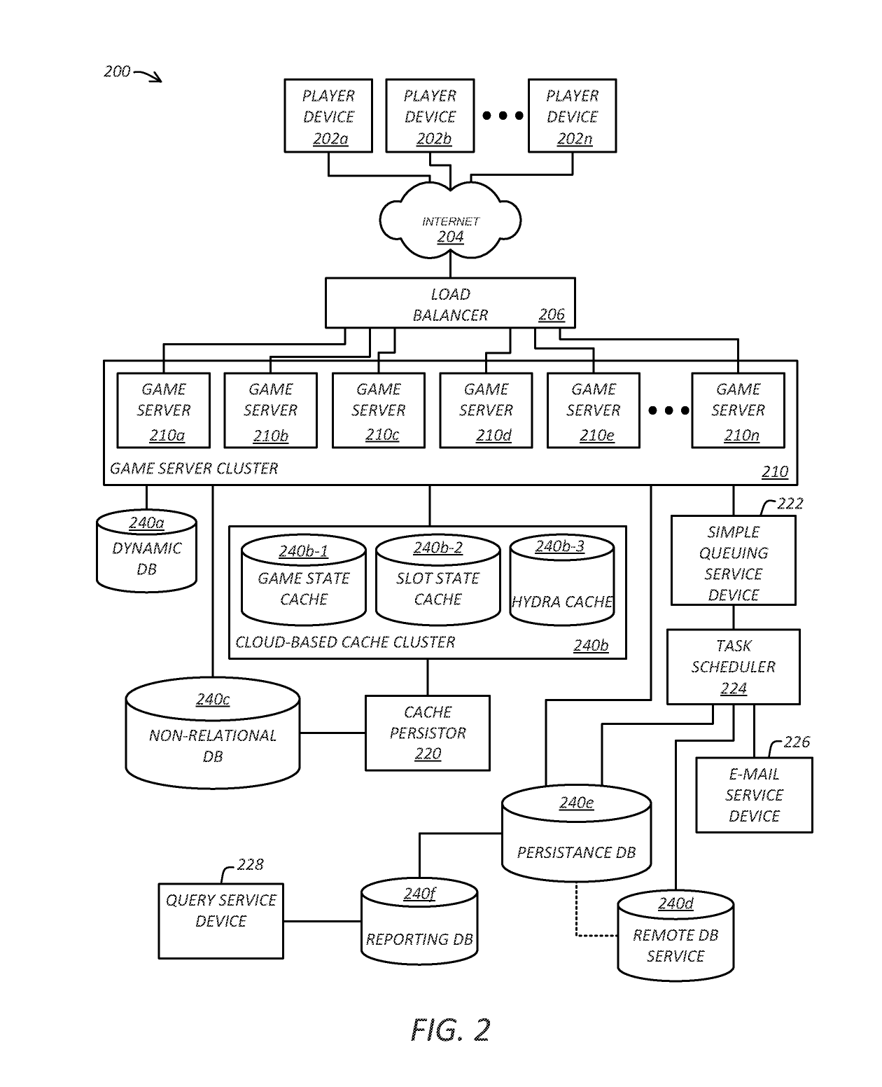

FIG. 2 a block diagram of an example system 200, which is consistent with some embodiments. In accordance with some embodiments, the system 200 may comprise a plurality of player devices 202a-n, the Internet 204, a load balancer 206, and/or a game server cluster 210. The game server cluster 210 may, in some embodiments, comprise a plurality of game servers 210a-n. In some embodiments, the system 200 may comprise a cache persistor 220, a Simple Queuing Service (SQS) device 222, a task scheduler 224, an e-mail service device 226, and/or a query service device 228. As depicted in FIG. 2, any or all of the various components 202a-n, 204, 206, 210a-n, 220, 222, 224, 226, 228 may be in communication with and/or coupled to one or more databases 240a-f. The system 200 may comprise, for example, a dynamic DataBase (DB) 240a, a cloud-based cache cluster 240b (e.g., comprising a game state cache 240b-1, a slot state cache 240b-2, and/or a “hydra” cache 240b-3), a non-relational DB 240c, a remote DB service 240d, a persistence DB 240e, and/or a reporting DB 240f.

According to some embodiments, any or all of the components 202a-n, 204, 206, 210a-n, 220, 222, 224, 226, 228, 240a-f of the system 200 may be similar in configuration and/or functionality to any similarly named and/or numbered components described herein. Fewer or more components 202a-n, 204, 206, 210a-n, 220, 222, 224, 226, 228, 240a-f (and/or portions thereof) and/or various configurations of the components 202a-n, 204, 206, 210a-n, 220, 222, 224, 226, 228, 240a-f may be included in the system 200 without deviating from the scope of embodiments described herein. While multiple instances of some components 202a-n, 210a-n, 240a-f are depicted and while single instances of other components 204, 206, 220, 222, 224, 226, 228 are depicted, for example, any component 202a-n, 204, 206, 210a-n, 220, 222, 224, 226, 228, 240a-f depicted in the system 200 may comprise a single device, a combination of devices and/or components 202a-n, 204, 206, 210a-n, 220, 222, 224, 226, 228, 240a-f, and/or a plurality of devices, as is or becomes desirable and/or practicable. Similarly, in some embodiments, one or more of the various components 202a-n, 204, 206, 210a-n, 220, 222, 224, 226, 228, 240a-f may not be needed and/or desired in the system 200.

According to some embodiments, the player device 202a-n may be utilized to access (e.g., via the Internet 204 and/or one or more other networks not explicitly shown) content provided by the game server cluster 210. The game server cluster 210 may, for example, provide, manage, host, and/or conduct various online and/or otherwise electronic games such as online bingo, slots, poker, and/or other games of chance, skill, and/or combinations thereof. In some embodiments, the various game servers 210a-n (virtual and/or physical) of the game server cluster 210 may be configured to provide, manage, host, and/or conduct individual instances of available game types. A first game server 210a, for example, may host a first particular instance of an online bingo game (or tournament), a second game server 210c may host a second particular instance of an online bingo game (or tournament), a third game server 210c may facilitate an online poker tournament, and/or a fourth game server 210d may provide an online slots game.

In some embodiments, the player devices 202a-n may comprise various components (hardware, firmware, and/or software; not explicitly shown) that facilitate game play and/or interaction with the game server cluster 210. The player device 202a-n may, for example, comprise a gaming client such as a software application programmed in Adobe® Flash® and/or HTML 5 that is configured to send requests to, and receive responses from, one or more of the game servers 210a-n of the game server cluster 210. In some embodiments, such an application operating on and/or via the player devices 202a-n may be configured in Model-View-Controller (MVC) architecture with a communication manager layer responsible for managing the requests to/responses from the game server cluster 210. In some embodiments, one or more of the game servers 210a-n may also or alternatively be configured in a MVC architecture with a communication manager and/or communications management layer. In some embodiments, communications between the player devices 202a-n and the game server cluster 210 may be conducted in accordance with the HyperText Transfer Protocol (HTTP) version 1.1 (HTTP/1.1) as published by the Internet Engineering Taskforce (IET) and the World Wide Web Consortium (W3C) in RFC 2616 (June 1999).

According to some embodiments, communications between the player devices 202a-n and the game server cluster 210 may be managed and/or facilitated by the load balancer 206. The load balancer 206 may, for example, route communications from player devices 202a-n to one or more of the specific game servers 210a-n depending upon various attributes and/or variables such as bandwidth availability (e.g., traffic management/volumetric load balancing), server load (e.g., processing load balancing), server functionality (e.g., contextual awareness/availability), and/or player-server history (e.g., session awareness/stickiness). In some embodiments, the load balancer 206 may comprise one or more devices and/or services provided by a third-party (not shown). The load balancer 206 may, for example, comprise an Elastic Load Balancer (ELB) service provided by Amazon® Web Services, LLC of Seattle, Wash. According to some embodiments, such as in the case that the load balancer 206 comprises the ELB or a similar service, the load balancer 206 may manage, set, determine, define, and/or otherwise influence the number of game servers 210a-n within the game server cluster 210. In the case that traffic and/or requests from the player devices 202a-n only require the first and second game servers 210a-b, for example, all other game servers 210c-n may be taken off-line, may not be initiated and/or called, and/or may otherwise not be required and/or utilized in the system 200. As demand increases (and/or if performance, security, and/or other issues cause one or more of the first and second game servers 210a-b to experience detrimental issues), the load balancer 206 may call and/or bring online one or more of the other game servers 210c-n depicted in FIG. 2. In the case that each game server 210a-n comprises an instance of an Amazon® Elastic Compute Cloud (EC2) service, the load balancer 206 may add or remove instances as is or becomes practicable and/or desirable.

In some embodiments, the load balancer 206 and/or the Internet 204 may comprise one or more proxy servers and/or devices (not shown in FIG. 2) via which communications between the player devices 202a-n and the game server cluster 210 are conducted and/or routed. Such proxy servers and/or devices may comprise one or more regional game hosting centers, for example, which may be geographically dispersed and addressable by player devices 202a-n in a given geographic proximity. In some embodiments, the proxy servers and/or devices may be located in one or more geographic areas and/or jurisdictions while the game server cluster 210 (and/or certain game servers 210a-n and/or groups of game servers 210a-n thereof) is located in a separate and/or remote geographic area and/or jurisdiction.

According to some embodiments, for some game types the game server cluster 210 may provide game outcomes to a controller device (not separately shown in FIG. 2) that times the release of game outcome information to the player devices 202a-n such as by utilizing a broadcaster device (also not separately shown in FIG. 2) that transmits the time-released game outcomes to the player devices 202a-n (e.g., in accordance with the Transmission Control Protocol (TCP) and Internet Protocol (IP) suite of communications protocols (TCP/IP), version 4, as defined by “Transmission Control Protocol” RFC 793 and/or “Internet Protocol” RFC 791, Defense Advance Research Projects Agency (DARPA), published by the Information Sciences Institute, University of Southern California, J. Postel, ed. (September 1981)).

In some embodiments, the game server cluster 210 (and/or one or more of the game servers 210a-n thereof) may be in communication with the dynamic DB 240a. According to some embodiments, the dynamic DB 240a may comprise a dynamically-scalable database service such as the DyanmoDB™ service provided by Amazon® Web Services, LLC. The dynamic DB 240a may, for example, store information specific to one or more certain game types (e.g., a reeled slots themed game) provided by the game server cluster 210 such as to allow, permit, and/or facilitate reporting and/or analysis of such information.

According to some embodiments, the game server cluster 210 (and/or one or more of the game servers 210a-n thereof) may be in communication with the cloud-based cache cluster 240b. Game state information from the game server cluster 210 may be stored in the game state cache 240b-1, for example, slot state (e.g., slot-game specific state) data may be stored in the slot state cache 240b-2, and/or other game and/or player information (e.g., progressive data, player rankings, audit data) may be stored in the hydra cache 240b-3. In some embodiments, the cache persistor 220 may move and/or copy data stored in the cloud-based cache cluster 240b to the non-relational DB 240c. The non-relational DB 240c may, for example, comprise a SimpleDB™ service provided by Amazon® Wed Services, LLC. According to some embodiments, the game server cluster 210 may generally access the cloud-based cache cluster 240b as-needed to store and/or retrieve game-related information. The data stored in the cloud-based cache cluster 240b may generally comprise a subset of the newest or freshest data, while the cache persistor 220 may archive and/or store or move such data to the non-relational DB 240c as it ages and/or becomes less relevant (e.g., once a player logs-off, once a game session and/or tournament ends). The game server cluster 210 may, in accordance with some embodiments, have access to the non-relational DB 240c as-needed and/or desired. The game servers 210a-n may, for example, be initialized with data from the non-relational DB 240c and/or may store and/or retrieve low frequency and/or low priority data via the non-relational DB 240c.

In some embodiments, the SQS device 222 may queue and/or otherwise manage requests, messages, events, and/or other tasks or calls to and/or from the server cluster 210. The SQS device 222 may, for example, prioritize and/or route requests between the game server cluster 210 and the task scheduler 224. In some embodiments, the SQS device 222 may provide mini-game and/or tournament information to the server cluster 210. According to some embodiments, the task scheduler 224 may initiate communications with the SQS device 222, the e-mail service provider 226 (e.g., providing e-mail lists), the remote DB service 240d (e.g., providing inserts and/or updates), and/or the persistence DB 240e (e.g., providing and/or updating game, player, and/or other reporting data), e.g., in accordance with one or more schedules.

According to some embodiments, the persistence DB 240e may comprise a data store of live environment game and/or player data. The game server cluster 210 and/or the task scheduler 224 or SQS device 222 may, for example, store game and/or player data to the persistence DB 240e and/or may pull and/or retrieve data from the persistence DB 240e, as-needed and/or desired. The server cluster 210 may, according to some embodiments, provide and/or retrieve spin and/or other game event info and/or configuration information via the persistence DB 240e.

In some embodiments, the reporting DB 240f may be created and/or populated based on the persistence DB 240e. On a scheduled and/or other basis, for example, a data transformation and/or mapping program may be utilized to pull data from the live environment (e.g., the persistence DB 240e) into the reporting DB 240f. The query service 228 may then be utilized, for example, to query the reporting DB 240f, without taxing the live environment and/or production system directly accessible by the game server cluster 210.

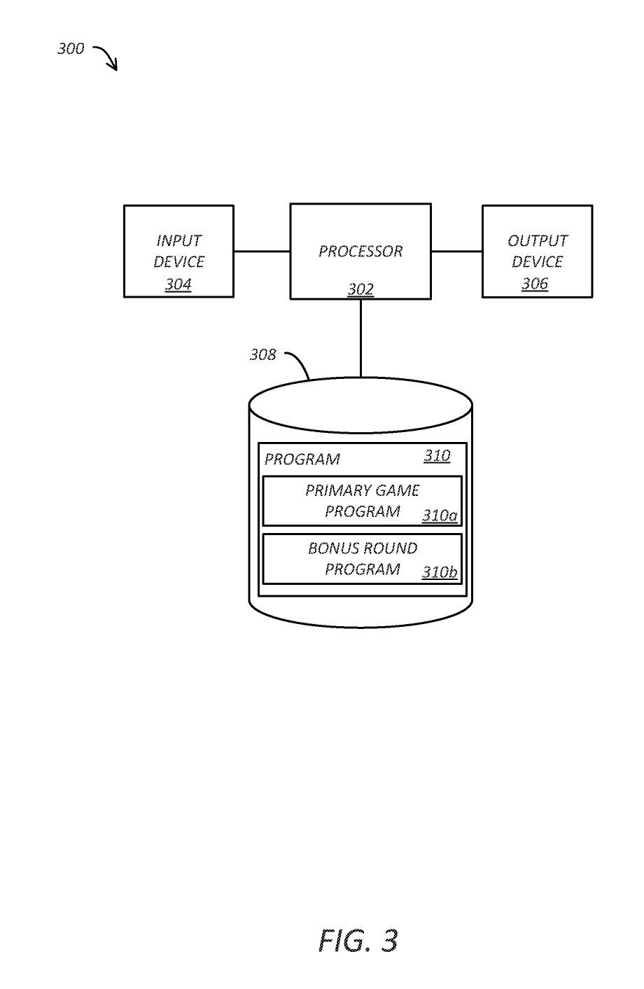

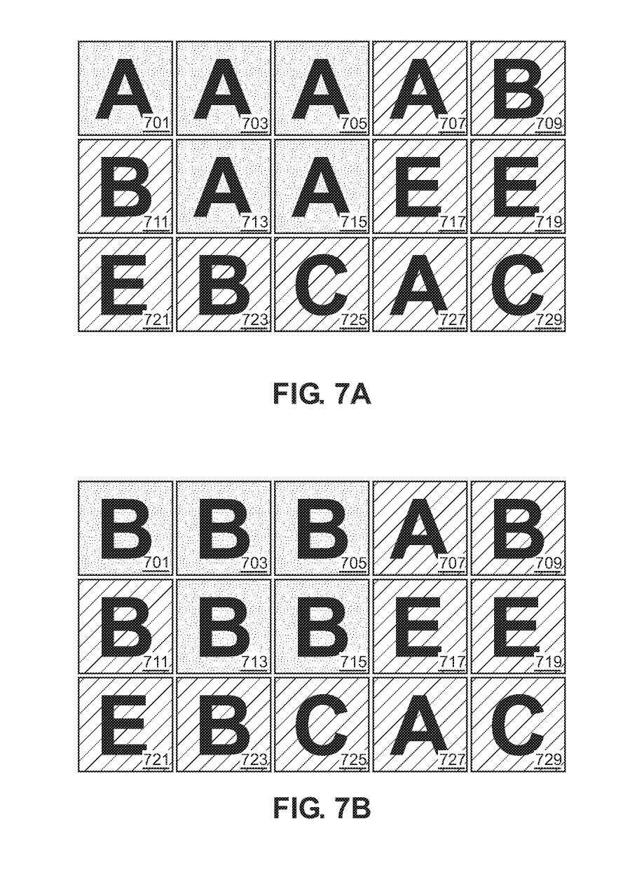

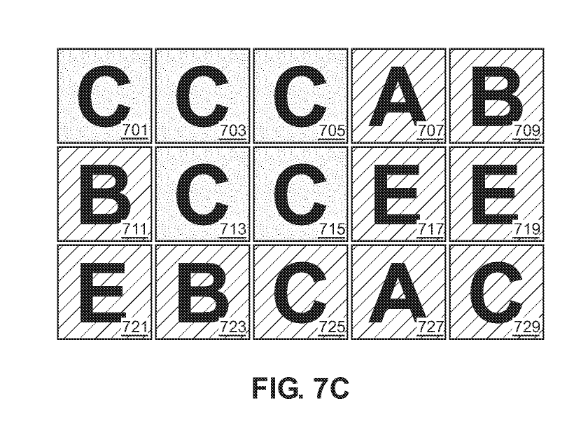

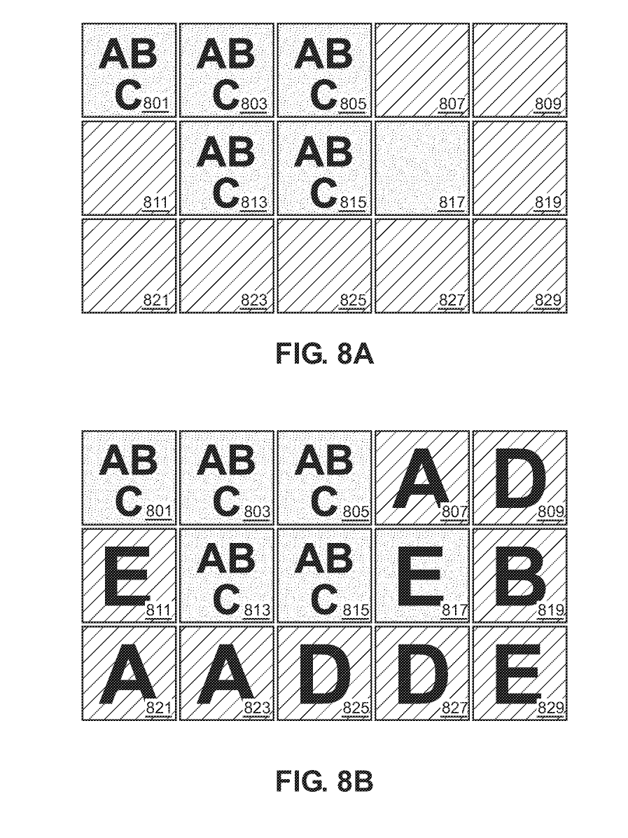

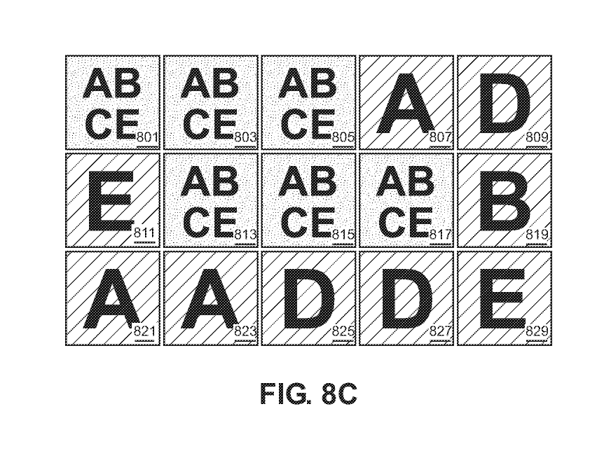

FIG. 3 is a block diagram of an apparatus 300 according to some embodiments. In some embodiments, the apparatus 300 may be similar in configuration and/or functionality to any of the player devices 102, the game server 110 and/or another server device operable to facilitate the embodiments described herein. The apparatus 300 may, for example, execute, process, facilitate, and/or otherwise be associated with any of the processes 700 and/or 800 described herein in conjunction with FIG. 7 and FIG. 8, respectively.

In some embodiments, the apparatus 300 may comprise a processor 302, an input device 304, an output device 306 and/or a memory device 308. Fewer or more components and/or various configurations of the components 302, 304, 306 and/or 308 may be included in the apparatus 300 without deviating from the scope of embodiments described herein.

According to some embodiments, the processor 302 may be or include any type, quantity, and/or configuration of processor that is or becomes known. The processor 302 may comprise, for example, an Intel® IXP 2800 network processor or an Intel® XEON™ Processor coupled with an Intel® E7501 chipset. In some embodiments, the processor 302 may comprise multiple inter-connected processors, microprocessors, and/or micro-engines. According to some embodiments, the processor 302 (and/or the apparatus 300 and/or other components thereof) may be supplied power via a power supply (not shown) such as a battery, an Alternating Current (AC) source, a Direct Current (DC) source, an AC/DC adapter, solar cells, and/or an inertial generator. In the case that the apparatus 302 comprises a server such as a blade server, necessary power may be supplied via a standard AC outlet, power strip, surge protector, and/or Uninterruptible Power Supply (UPS) device.

In some embodiments, the input device 304 and/or the output device 306 are communicatively coupled to the processor 302 (e.g., via wired and/or wireless connections and/or pathways) and they may generally comprise any types or configurations of input and output components and/or devices that are or become known, respectively.

The input device 304 may comprise, for example, a keyboard that allows an operator of the apparatus 300 to interface with the apparatus 200 (e.g., by a player, an employee or other worker affiliated with either an online casino or other entity operating a system which provides games to players). In some embodiments, the input device 304 may comprise a mechanism configured to indicate to a remote server device an initiation or triggering of an event instance or a request for a result of a game event (e.g., that a player has actuated a “reel spin” mechanism and thus initiated a new spin of a reels-based game), such information being provided to the apparatus 300 and/or the processor 302. In such embodiments, the input device may comprise a key on a keyboard of the apparatus 300. Other examples of input devices include, but are not limited to: a game controller and/or gamepad, a bar-code scanner, a magnetic stripe reader, a pointing device (e.g., a computer mouse, touchpad, and/or trackball), a point-of-sale terminal keypad, a touch-screen, a microphone, an infrared sensor, a sonic ranger, a computer port, a video camera, a motion detector, a digital camera, a network card, a Universal Serial Bus (USB) port, a GPS receiver, a Radio Frequency Identification (RFID) receiver, a RF receiver, a thermometer, a pressure sensor, and a weight scale or mass balance.

The output device 306 may, according to some embodiments, comprise a display screen and/or other practicable output component and/or device that is operable to output information. The output device 306 may, for example, comprise a display screen via which are output outcomes, instructions, guidance, questions or information to a player of a game. Some examples of output devices that may be useful in some embodiments include a Cathode Ray Tube (CRT) monitor, a Liquid Crystal Display (LCD) screen, a Light Emitting Diode (LED) screen, a printer, an audio speaker, an Infra-red Radiation (IR) transmitter, an RF transmitter, and/or a data port. According to some embodiments, the input device 304 and/or the output device 306 may comprise and/or be embodied in a single device such as a touch-screen display or screen.

In some embodiments, the apparatus 300 may comprise any type or configuration of communication device (not shown) that is or becomes known or practicable. For example, the apparatus 300 may include a communication device such as a NIC, a telephonic device, a cellular network device, a router, a hub, a modem, and/or a communications port or cable. In some embodiments, the communication device may be coupled to provide data to a telecommunications device. The communication device may, for example, comprise a cellular telephone network transmission device that sends signals (e.g., an initiation of an event instance) to a server (e.g., game server 110) in communication with a plurality of player devices 102. According to some embodiments, the communication device may also or alternatively be coupled to the processor 302. In some embodiments, the communication device may comprise an IR, RF, Bluetooth™, and/or Wi-Fi® network device coupled to facilitate communications between the processor 202 and another device.

The memory device 308 may comprise any appropriate information storage device that is or becomes known or available, including, but not limited to, units and/or combinations of magnetic storage devices (e.g., a hard disk drive), optical storage devices, and/or semiconductor memory devices such as Random Access Memory (RAM) devices, Read Only Memory (ROM) devices, Single Data Rate Random Access Memory (SDR-RAM), Double Data Rate Random Access Memory (DDR-RAM), and/or Programmable Read Only Memory (PROM).

The memory device 308 may, according to some embodiments, store a program 310 for facilitating one or more of the embodiments described herein, which program may include a primary game program 310a for facilitating a primary aspect of a game. In some embodiments, a game may further include a bonus round and the program 310 may further include a bonus round program 310b for facilitating the bonus round of the game. In some embodiments, the primary game program 310a and/or the bonus round program 310b may be utilized by the processor 302 to provide output information via the output device 306.

The primary game program 310a may, for example, provide instructions for determining at least one of: (i) an outcome for the primary game responsive to a wager or other input from a player which initiates an event instance of the game (e.g., by requesting a random number from another server or device), (ii) which symbol positions (e.g., reel positions) should be populated with which symbols; (iii) whether the outcome of the comprises or has triggered the creation of a Blended Symbol(s); (iv) increasing the credit balance of the player based on any payouts won as a result of the outcome; (v) a corresponding area of effect for a particular Blended Symbol; (vi) which regular symbols a particular Blended Symbol is substitutable for based on the area of effect corresponding to the Blended Symbol and the regular symbols populating the symbol positions within the area of effect; and/or (iv) re-evaluating each payline to determine whether the player has won any additional payouts as a result of a regular symbol being replaced with a Blended Symbol.

The apparatus 300 may function as a computer terminal and/or server of an online casino or other entity operating to provide online games, receive and/or manage information related to online games. In some embodiments, the apparatus 300 may comprise a web server and/or other server device operable to accept wagers and determine random numbers based upon which outcomes for wagering games are determined. In some embodiments, the apparatus 300 may comprise an apparatus that is operable to interact with a player of an online game. In some embodiments, apparatus 300 may comprise a plurality of devices working together to accomplish the functionality described herein with respect to FIG. 3.

Any or all of the exemplary instructions and data types described herein and other practicable types of data may be stored in any number, type, and/or configuration of memory devices that is or becomes known. The memory device 308 may, for example, comprise one or more data tables or files, databases, table spaces, registers, and/or other storage structures. In some embodiments, multiple databases and/or storage structures (and/or multiple memory devices 308) may be utilized to store information associated with the apparatus 300. According to some embodiments, the memory device 308 may be incorporated into and/or otherwise coupled to the apparatus 300 (e.g., as shown) or may simply be accessible to the apparatus 200 (e.g., externally located and/or situated).

In accordance with some embodiments, systems, methods and articles of manufacture provide for determining special symbols in a game by: (a) providing a game interface comprising a plurality of symbol positions, the plurality of symbol positions arranged in a plurality of rows and a plurality of columns, each column of the plurality of columns representing a reel of a slot-machine type game, wherein the game further comprises a plurality of paylines, each payline comprising a plurality of symbol positions such that a winning outcome comprises a predetermined combination of symbols being displayed in the symbol positions comprising a payline of the plurality of paylines upon a resolution of a game event; (b) identifying any winning results based on an initial outcome of a game event; (c) causing, for each identified winning outcome, a corresponding payout to be awarded to a player currently playing the game; (d) identifying that a first regular symbol of the game displayed in a first symbol position qualifies to be designated as a Blended Symbol (or, in some embodiments, to be replaced with a Blended Symbol), wherein a Blended Symbol comprises a symbol which functions as (e.g., is substitutable for) at least one of a plurality of regular symbols for at least one outcome; (e) determining an area of effect corresponding to the Blended Symbol, the area of effect comprising a plurality of symbol positions of the game interface which is less than all of the symbol positions of the game interface (in some embodiments, the area of effect includes the first symbol position); (f) determining, for each symbol positing comprising the area of effect, which regular symbol is displayed in such symbol position, thereby identifying the plurality of regular symbols the Blended Symbol functions as (e.g., the plurality of symbols the Blended Symbol is substitutable for); (g) re-evaluating at least one payline of the game interface while treating the Blended Symbol as at least one of the plurality of regular symbols the Blended Symbol functions as (e.g., while treating the Blended Symbol as substitutable for any of the plurality of regular symbols displayed in symbol positions comprising the area of effect), to determine whether any additional winning results have been created based on the Blended Symbol; and (i) causing, for each identified additional winning result, a corresponding payout to be awarded to the player.

In accordance with some embodiments, systems, methods and articles of manufacture (e.g., non-transitory computer-readable media) provide for facilitating a game which includes Blended Symbols by: (a) providing a game interface comprising a plurality of symbol positions, the plurality of symbol positions arranged in a plurality of rows and a plurality of columns, each column of the plurality of columns representing a reel of a slot-machine type game, wherein the game further comprises a plurality of paylines, each payline comprising a plurality of symbol positions such that a winning outcome comprises a predetermined combination of symbols being displayed in the symbol positions comprising a payline of the plurality of paylines upon a resolution of a game event; (b) receiving a request to determine a result of a game event of the game; (c) determining, in response to the request, a plurality of regular symbols for the game event; (d) populating the plurality of regular symbols into the symbol positions of the game interface by placing, into each symbol position, one regular symbol of the plurality of regular symbols determined for the game event; (e) identifying that a first regular symbol of the plurality of regular symbols is to function as a first Blended Symbol in determining the result of the game event, wherein a Blended Symbol comprises a symbol which functions as at least one symbol of a subset of regular symbols available in the game (e.g., the Blended Symbol is substitutable for a subset of the plurality of regular symbols determined for the game event) in determining results for game events of the game, the subset being greater than one and being determined based on the plurality of regular symbols determined for the game event in which the Blended Symbol is to be applied; (f) determining a particular subset of regular symbols for the Blended Symbol (e.g., a subset of regular symbols which the first regular symbol is substitutable for) in determining the result of the game event by determining at least one second regular symbol of the plurality of symbols determined for the game event; (g) evaluating each active payline of the game event to determine the result of the game event, wherein the first regular symbol is considered to function as at least one of (e.g., either of) the first regular symbol and the at least one second regular symbol when determining the result of the game event; and (h) for each winning outcome comprising the result, causing a corresponding payout to be provided to a player associated with the game event.

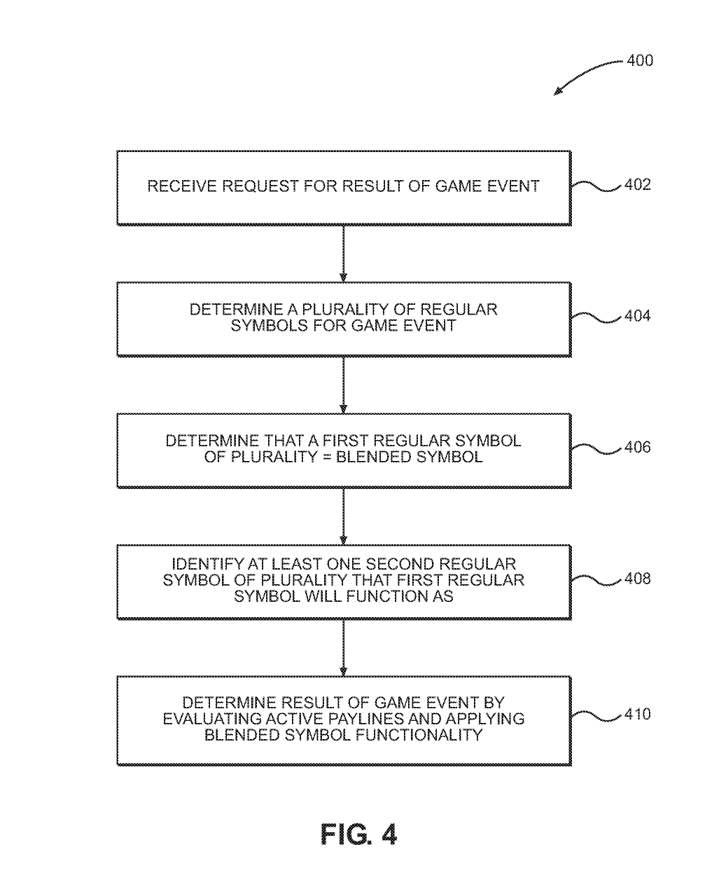

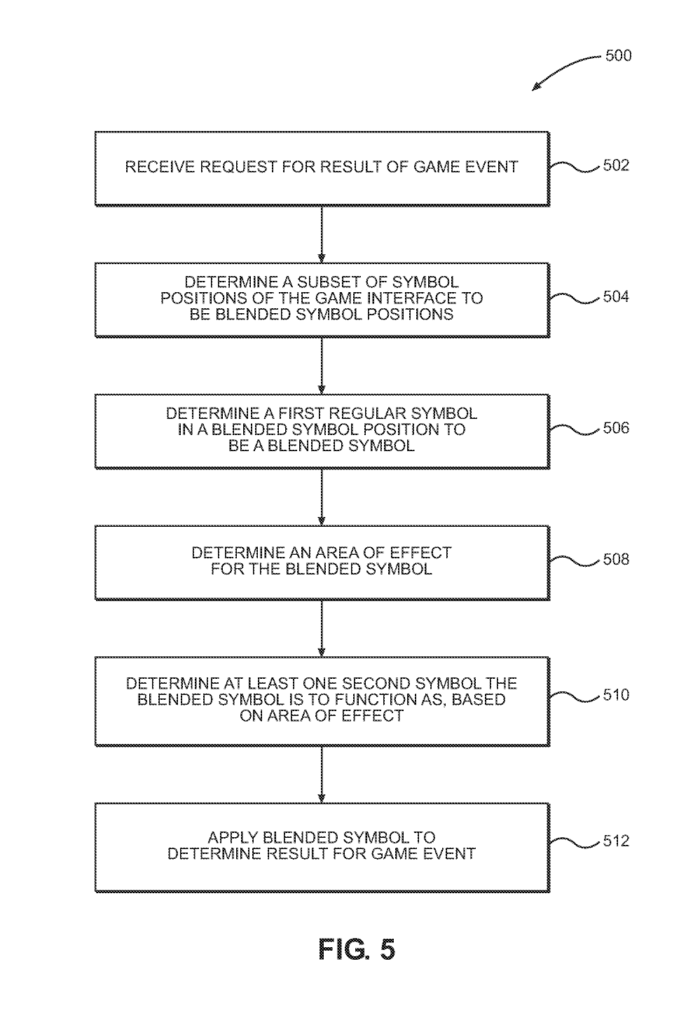

Referring now to FIG. 4 and FIG. 5, illustrated in each of these figures is a respective process flowchart depicting an example process (process 400 being depicted in FIG. 4 and process 500 being depicted in FIG. 5), each of which is consistent with some embodiments described herein. Each of the processes 400 and 500 may comprise a respective and different process for implementing the Blended Symbol feature described herein.

Either or both process 400 and process 500 may be performed, for example, by at least one of a server device operable to facilitate an electronic (e.g., online) game and/or a player device enabling a player to play the electronic (e.g., online) game. For example, the processes 400 or the process 500 may be performed by at least one of (i) a player device 102 (FIG. 1); (ii) a game server 110 (FIG. 1); (iii) a player device 202 (FIG. 2); (iv) a game server 210 (FIG. 2); and (v) apparatus 300 (FIG. 3). It should be noted that additional and/or different steps may be added to those depicted in either flowchart and that not all steps depicted are necessary to any embodiment described herein. Rather, the process 400 and the process 500 are each a respective example process of how some embodiments described herein may be implemented, and should not be taken in a limiting fashion. A person of ordinary skill in the art, upon contemplation of the embodiments described herein, may make various modifications to process 400 and/or process 500 without departing from the spirit and scope of the embodiments in the possession of applicants.

Turning now to FIG. 4 in particular, process 400 begins in step 402 in which step a request for a result of a game is received. This step may comprise, for example, receiving a signal or indication that an initiation or triggering of a game event has been detected or recognized at a player device 102 (e.g., receiving an indication that a player has actuated a “spin” mechanism and thus initiated a new spin or game instance of a reels-based game, a “deal” mechanism of a card game or a “start” or “bet” mechanism of another type of game). Step 402 may comprise receiving or recognizing any indication, signal, event or request which causes the remainder of process 400 to be performed.

In step 404, a plurality of regular symbols are determined for a game event. This step may be similar to what would normally happen in a conventional game when a request for determining a result of the game event is received: an outcome for the game event is determined by, for example, determining which regular symbols to place into a game interface of the game based on the outcome or a desired result for the game. In one embodiment, in a game in which outcomes and results are determined based on a random or pseudo-random algorithm, a random number may be determined for the game event (e.g., directly by the device performing process 400 or indirectly by requesting or receiving such random number from another device, such as a server device programmed to generate such random number for use in determining results of the game). The random number may then, in some embodiments, be utilized to determine the regular symbols to be placed into a game interface of the game or to otherwise use as an outcome for the game event. Any desired process or mechanism may be implemented for determining the plurality of regular symbols for the game event and the embodiments described herein are not dependent on any particular process for determining the plurality of regular symbols.

It should be noted that although a plurality of regular symbols may be determined for the game event in step 404, they may not necessarily be placed yet into symbol positions of a game interface and/or displayed to a player via the game interface. In some embodiments, step 404 (or an additional step in the process 400) may comprise placing the plurality of regular symbols into symbol positions of a game interface, whether such symbol positions are within an area of the game interface visible to a player or otherwise (e.g., determining which regular symbol will be placed into which symbol position if the game interface comprises a grid of individual cells for placement of symbols or determining which reels a regular symbol or subset of the regular symbols will be displayed on). In some embodiments in which additional game mechanics are implemented to replace, augment or modify regular symbols prior to output or placement in a game interface, such game mechanics may be applied as part of step 404 or as part of a different step or subroutine.

In step 406 it is determined that at least one of the regular symbols of the plurality of regular symbols determined in step 404 is to be designated as (or function as) a Blended Symbol for the current game event. For example, at least one of the regular symbols of the plurality of symbols determined in step 404 may be selected or identified as a Blended Symbol based on a rule of the game. In one embodiment, a separate step or sub-routine may first be performed to determine whether, for the current game event, at least one of the regular symbols should be designated a Blended Symbol (e.g., not each game event will include a Blended Symbol).

In one embodiment a sub-routine is implemented to select, in accordance with a random or pseudo-random algorithm, at least one regular symbol of a plurality of regular symbols determined for the game event to be a Blended Symbol. In another embodiment, a regular symbol is determined to be a Blended Symbol for the current game event if it is placed in a particular symbol position of a game interface or a symbol position corresponding to a predetermined characteristic. For example, a symbol position may correspond to a predetermined characteristic which results in a regular symbol placed within the symbol position to be designated a Blended Symbol for the current game event (e.g., the symbol position is within an area of effect or is a “catch” symbol position as described below). In another embodiment, a regular symbol may be designated a Blended Symbol based on a positional relationship it bears to one or more other symbols. For example, in one embodiment if a certain symbol is next to two adjacent symbols of the same type or a plurality of symbols of the same type are placed in symbol positions contiguous to one another then, in some embodiments, at least one of the symbols in such a grouping may be designated a Blended Symbol. In yet another embodiment, a regular symbol may be designated a Blended Symbol based on a selection, preference or input from a player or other data associated with a player or current game event (e.g., a magnitude of a wager for the current game event, whether the player has obtained a Blended Symbol within the past X game events, etc.). In other embodiments, certain predetermined special symbols may be Blended Symbols and step 404 may comprise determining whether the plurality of symbols determined for the game event includes a Blended Symbol (rather than selecting a regular symbol to be designated as a Blended Symbol).

In step 408, the plurality of regular symbols the Blended Symbol determined in step 406 is to function as for purposes of the current game event is determined. As described herein, the plurality of regular symbols which a Blended Symbol functions as may be predetermined in some embodiments. However, for purposes of the embodiment illustrated via process 400, the plurality of regular symbols which a Blended Symbol functions as is dynamically determined from the plurality of symbols determined for the game event in step 404. In accordance with one embodiment, a subset of the plurality of symbols determined for the game event (as determined in step 404) is selected as the plurality of symbols which the Blended Symbol functions as. In one embodiment, the at least one regular symbol designated as the Blended Symbol in step 406 is one of the regular symbols the Blended Symbol is to function as.

In some embodiments a Blended Symbol functioning as a plurality of symbols may comprise the Blended Symbol being treated as a combination of the plurality of symbols. For example, if the Blended Symbol functions as symbols A and B, then an evaluation of the payline may comprise treating the payline as including both symbols A and B for purposes of identifying any winning outcomes along the payline. In other embodiments, a Blended Symbol functioning as a plurality of symbols may comprise the Blended Symbol being substitutable, in the alternative, for any of the symbols comprising the plurality of symbols the Blended Symbol is substitutable for. For example, if the Blended Symbol functions as symbols A or B in the alternative, then an evaluation of the payline may comprise treating the payline as including either symbol A or symbol B for purposes of identifying any winning outcomes along the payline. In another embodiment, a Blended Symbol functioning as a plurality of symbols may comprise the Blended Symbol functioning as some game mechanic which applies the symbols in some other manner for purposes of determining a result of the game event. For example, if each of the regular symbols which the Blended Symbols functions as corresponds to some functionality (e.g., the first regular symbol causes payouts to be multiplied and the second regular symbol causes a bonus round to be triggered), applying a Blended Symbol in evaluating a result or outcome for a game event may comprise applying all the respective functionalities (or a subset of the functionalities, which may be selected by the system or the player).

Determining the plurality of regular symbols a Blended Symbol functions as, based on the plurality of regular symbols determined for the game event, may be done in any number of manners. In one embodiment, a subset of the plurality of regular symbols determined for the game event is determined based on a random, pseudo-random or weighted random algorithm. For example, a predetermined number (e.g., three) other regular symbols of the plurality of regular symbols determined for the game event are selected. In another embodiment, the regular symbols placed within a predetermined positional relationship or arrangement with respect to the first regular symbol (designated as the Blended Symbol in step 406) may be selected. For example, all regular symbols in symbol positions adjacent to or contiguous with the symbol position (in some embodiments, up to a predetermined maximum number of such adjacent or contiguous symbol positions) in which the first regular symbol designated as the Blended Symbol is placed may be selected. In another example, all regular symbols on the same reel as the first regular symbol designated as the Blended Symbol may be selected. In yet another example, all regular symbols that are of the same type or categorized in the same category as the first regular symbol (designated as the Blended Symbol in step 406) and that are in symbol positions contiguous with or adjacent to the first regular symbol may be selected in step 408. In yet another embodiment, all regular symbols that are the same type (or within the same category of symbols) as the first regular symbol designated as the Blended Symbol (or a subset of such regular symbols of the same type or within the same category) may be selected, regardless of which symbol position they are placed in.

In another embodiment, all regular symbols placed within an area of effect corresponding to the Blended Symbol (or a subset of such regular symbols) may be selected. An area of effect may comprise a predetermined set of symbol positions in a game interface. In some embodiments, the area of effect may be determined via a distinct process (e.g., via a random, pseudo-random or weighted random algorithm for selecting a plurality of symbol positions to define an area of effect for a particular game event). In some embodiments, the area of effect may be determined based on the regular symbols which have been placed in a game interface. For example, symbol positions into which regular symbols of a particular type (e.g., the same type as the first regular symbol or regular symbols which are categorized in the same category as the first regular symbol) may be selected as the symbol positions defining the area of effect for the game event.

In one embodiment, a player may be allowed to select at least one second regular symbol of the plurality of regular symbols determined in step 404 to be a symbol which the Blended Symbol is to function as. In another embodiment, at least one second regular symbol of the plurality of regular symbols determined in step 404 may be selected based on data associated with a player even if it is not directly selected by the player. For example, the at least one second regular symbol may be selected based on a preference of a player, based on a status or rating of a player, based on a magnitude of wager (or magnitude of an average wager) placed by a player or based on optimizing a result of the game event for the player based on a status of the game event.

Once the Blended Symbol is determined (in step 406) and the at least one second symbol it is to function as is determined (in step 408), the result of the game event is determined by evaluating each of the active paylines of the game event and applying the functionality or functionalities of the Blended Symbol thereto (step 410). An active payline is, in accordance with some embodiments, a payline included in a wager placed by the player or which otherwise contributes to a player's progress or rewards in a game. Step 410 may comprise determining, for each active payline whether the outcome of the payline includes a winning combination and, if so, the payout or other award to provide to the player. In some embodiments, step 410 (or an additional step of process 400) may also include increasing the credit balance of the player based on any payouts won as a result of the game event. The payouts or other rewards the player qualifies for, based on the symbols (including the Blended Symbol and the regular symbols the Blended Symbol is substitutable for or otherwise functions as) may be referred to as the result of the game event.

As an illustrative and non-limiting example of step 410, assume the regular symbols of a game include A and B and that a symbol A has been placed in a symbol position which is along payline 1 of the game interface in step 404. Further assume that (i) the particular symbol A placed in the first symbol position of the payline 1 is designated as a Blended Symbol in step 406 and (ii) a regular symbol B is determined to be the at least one second regular symbol the Blended Symbol function as and that functioning as symbol B means, for purposes of the present example, that the Blended Symbol is substitutable for symbol B (symbol B having been one of the plurality of regular symbols determined in step 404 and placed in another symbol position in the game interface, whether along payline 1 or otherwise). Assume the winning combinations of symbols for the game include: (i) 3 A symbols along a payline (paying out 2 credits) and (ii) 3 B symbols along the payline (paying out 2 credits). Assume the symbols along payline 1 consist of, in order (before the functionality of the Blended Symbol is taken into account and assuming the Blended Symbol is the first A, as indicated by the asterisk): A*-A-A-B-B. In accordance with one embodiment, step 410 may comprise (i) evaluating payline 1 by first treating the Blended Symbol A as an A (since this is the regular symbol which was designated as the Blended Symbol) and determining that a payout of 2 credits is to be awarded based on this evaluation because there are 3 A symbols along the payline; and (ii) further evaluating payline 1 by substituting a B for the Blended Symbol A in the first symbol position of the payline 1, such that the symbols along the payline are treated as B-A-A-B-B, thereby determining that an additional payout of 2 credits is to be awarded based on this evaluation because there are 3 B symbols along the payline as a result of the functionality of the Blended Symbol. Thus, in the present example and as a result of the functionality of the Blended Symbol, a player would be awarded 4 credits rather than the 2 credits the player would have been awarded if the functionality of the Blended Symbol had not been taken into account.

In accordance with some embodiments, after one or more symbols is determined or designated to be a Blended Symbol, the one or more Blended Symbols may lock (e.g., for at least one subsequent spin or cascade, fall off or be removed from the game interface after a contributing to a winning outcome, etc.) or otherwise be associated with a special function or ability. Thus, for example, once a result of a current game event is determined by evaluating each active payline and applying any Blended Symbol appearing along each such payline, it may be determined whether any of the Blended Symbols are to remain in their symbol positions for a subsequent game event (e.g., a new spin or outcome determination or a cascade triggered as a result of a current spin). If the Blended Symbol is to remain in its symbol position for a subsequent game event, the other regular symbols may be removed from the game interface and replaced with additional regular symbols while the Blended Symbol(s) remain in their current symbol positions (or, in some embodiments, remain within the game interface but be shifted to a different symbol position) for a subsequent game event. Whether such a locking in of Blended Symbols (and/or an area of effect corresponding to the Blended Symbol) is triggered may, in some embodiments, be based upon whether any winning combinations of symbols have been created (e.g., as a result of a Blended Symbol being applied to determine a result of a game event). In another embodiment, a special game mechanic defines how many spins or other game events the Blended Symbol(s) will persist for.

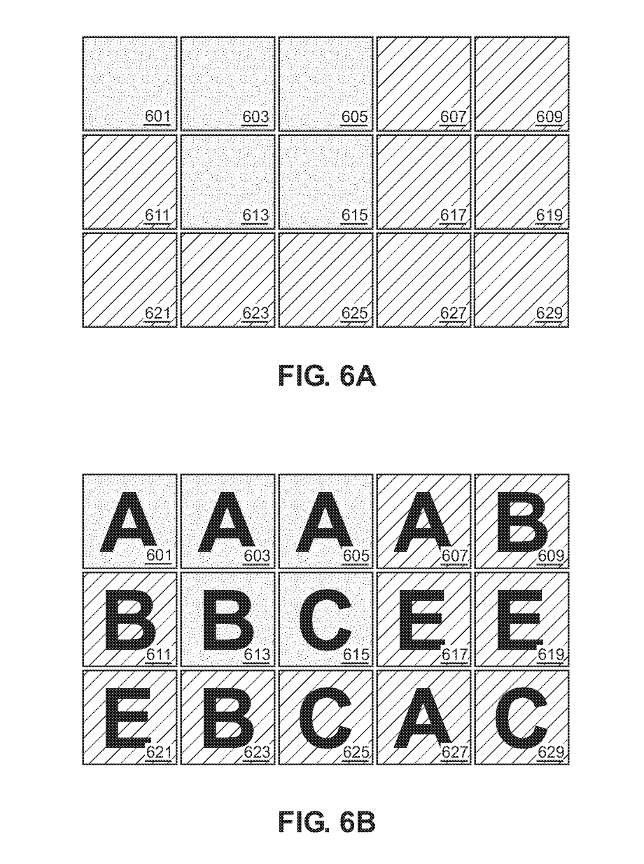

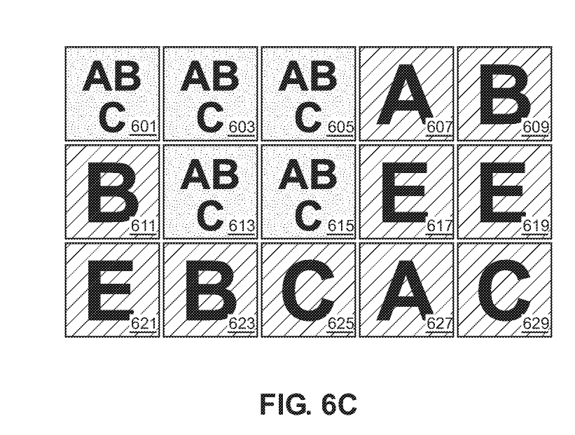

Turning now to FIG. 5, illustrated therein is a flowchart of an example process 500, which illustrates another embodiment. In the embodiment of FIG. 5, an area of effect is first defined for a game event and the determinations of a first regular symbol being designated as the Blended Symbol and the at least one second regular symbol the Blended Symbol functions as (e.g., is substitutable for) are both performed based on the regular symbols placed within symbol positions defining the area of effect. The process 500 is described with reference to FIGS. 6A-6C, which illustrate one example and non-limiting implementation of the process 500.

In step 502, a request for a result of a game event is received. This step may be substantially similar to step 402 of process 500 (FIG. 4) and will thus not be described again for purposes of brevity.

In step 504, a subset of symbol positions of a game interface are determined to be, designated as or selected as blended symbol positions. The blended symbol positions are not necessarily symbol positions which will cause a symbol placed therein to be designated a Blended Symbol. Rather, these are symbol positions which, in accordance with some embodiments, will be utilized to determine a Blended Symbol and an area of effect.

FIGS. 6A-6C illustrate an example game interface comprising a grid of five (5) columns and three (3) rows. Each intersection of a column and row is a symbol position. The symbol positions are identified as 601-629. The regular symbols available in the example game of FIGS. 6A-6C are “A”, “B”, “C”, “D” and “E.” FIGS. 6A-6C illustrate how the game interface may be modified or utilized to implement the embodiments of process 500. It should be noted that not all aspects of the grid illustrated in FIGS. 6A-6C may be output or visible to a player of the game but are illustrated in the figures as an aid to understanding how some embodiments may be implemented. It should be further understood that the grid illustrated in FIGS. 6A-6C may, when implemented as part of a game, be enhanced and accompanied by additional graphics or information related to the game. It is illustrated in a simple format herein to focus on aspects of the embodiments being described.

Turning now to FIG. 6A in particular, the illustration of the grid shows which symbol positions have been designated as comprising blended symbol positions (which may, in some embodiments, comprise an area of effect): symbol positions 601, 603, 605, 613 and 615. In accordance with one example and non-limiting embodiment, any symbol which is placed (e.g., as part of an initial or preliminary outcome for a game event) in a symbol position comprising a blended symbol position is going to be designated a Blended Symbol AND each such Blended Symbol will be determined to function as (e.g., be substitutable for) any other symbol appearing in any of the other blended symbol positions. FIG. 6A thus illustrates a result of step 504. As described, the designation of certain symbol positions as blended symbol positions may not, in some embodiments, be output or otherwise communicated to a player of the game (e.g., the symbol positions may be designed as blended symbol positions by the system and noted as such in a memory but a visual representation of which symbol positions have been designated blended symbol positions may not be output to a player). In other embodiments, a visual representation of which symbol positions have been designated as blended symbol positions may be output to a player. In some embodiments, blended symbol positions may be output for each game event (and/or a determination of whether a game event should include blended symbol positions may be performed dynamically for each game event). In other embodiments, blended symbol positions of a symbol position grid or other game interface may be predetermined or persistent for more than one game event (e.g., for all game events of a session, for all game events selected by a player, for all game events until a termination event occurs, etc.).

Returning to FIG. 5, once the blended symbol positions have been determined (step 504), at least one regular symbol which has been placed in one of the blended symbol positions is determined to be a (e.g., is designated or selected to be) a Blended Symbol for purposes of determining a result for the current game event. In accordance with some embodiments, each regular symbol placed in a blended symbol positions is determined to be a Blended Symbol, such that there is a plurality of Blended Symbols for the current game event. FIG. 6B illustrates such an embodiment. In other embodiments, a subset (e.g., one) of the regular symbols in the blended symbol positions is designated as a Blended Symbol. Which of the regular symbol(s) in the symbol positions is designated as a Blended Symbol may be determined, for example, (i) based on a predetermined rule of the game (e.g., the regular symbol in the left-most blended symbol position is selected or the regular symbol which would result in the most payouts being won by the player is selected); (ii) based on random, pseudo-random or weighted random algorithm; or (iii) based on a selection, input or preference of the player playing the game.

Turning now to FIG. 6B, the grid illustrates that a respective regular symbol “A” appears in each of the blended symbol positions 601, 603 and 605, a regular symbol “B” appears in blended symbol position 603 and a regular symbol “C” appears in blended symbol position 615. According to some embodiments, and the particular embodiment illustrated in FIGS. 6A-6C, each regular symbol appearing in a blended symbol position is designated a Blended Symbol. Thus, each of these regular symbols placed into blended symbol positions 601, 603, 605, 613 and 605 are designated as Blended Symbols for the current game event.

Turning now to FIG. 5, in step 508 an area of effect is determined for the one or more Blended Symbols determined in step 506. In accordance with some embodiments, a Blended Symbol functions as any symbol within its area of effect. Various methodologies for determining an area of effect have been described herein and will not be repeated with respect to step 508 for purposes of brevity. In accordance with one embodiment, an area of effect for a Blended Symbol is each symbol position which was determined to be a blended symbol position. In embodiments in which each symbol in a blended symbol position is designated as a Blended Symbol, this means that each regular symbol which was designated as a Blended Symbol functions as any (or all, if the symbols are combined rather than applied in the alternative) of the other Blended Symbols designated for the current game event. FIG. 6C illustrates such an embodiment. In the grid embodies in FIG. 6C, each of the symbols which appear in the blended symbol positions comprising the area of effect function as (e.g., are substitutable for) any of the other symbols appearing in the area of effect. Thus, each of the symbols in the blended symbol positions 601, 603, 605, 613 and 615 function as (e.g., are substitutable for) any of the symbols “A”, “B”, and/or “C”, which is a subset of the symbols available in the game.

It should be noted that, in accordance with some embodiments, not all “A”, “B” and “C” symbols are considered to be Blended Symbols for the game event in which these symbols were designated as Blended Symbols. It is only the symbols in particular symbol positions (e.g., the blended symbol positions) that are so designated. For example, the “A” symbol in symbol position 627 is not designated a Blended Symbol and does not function as any symbol other than “A” because symbol position 627 was not determined to be a blended symbol position and the symbol in this symbol position was not designated a Blended Symbol via any other means.

Turning again to FIG. 5, the Blended Symbol(s) are applied to determine a result of the game event (step 510). This may comprise, for example, evaluating each active payline and treating each Blended Symbol occurring along the payline in accordance with its functionality in order to determine whether a winning outcome has occurred along the active payline. For example, in an embodiment in which a Blended Symbol functioning as two or more regular symbols means that the Blended Symbol is substitutable for any one of the regular symbols, step 510 may comprise evaluating the outcomes of each payline by treating the Blended Symbol first as one of the regular symbols for which it is substitutable, then another, etc. In the particular example illustrated in FIG. 6C, assuming a payline comprises symbol positions 611, 613, 615, 617 and 619, applying the symbols “A”, “B” and “C” in the alternative to the blended symbol positions 613 and 615 would result in the following symbol combinations being determined for the payline: (i) B-A-A-E-E; (ii) B-B-A-E-E; (iii) C-C-A-E-E; (iv) B-A-B-E-E; (v) B-A-C-E-E; (vi) B-B-B-E-E; and (v) B-C-C-E-E. Assuming a player is provided with a payout for any winning outcome along this payline and assuming a winning outcome comprises an outcome which includes 3 or more of the same symbol along a payline, it can be appreciated that the player would be provided with a payout for the outcome (vi) B-B-B-E-E, which resulted from the symbols in blended symbol positions 613 and 615 both being treated as “B” symbols. It can also be appreciated, by viewing the regulars symbols which were originally placed in these symbol positions (as illustrated in FIG. 6B) that the player would not have otherwise received this payout, since the regular symbol in position 615 (prior to being designated a Blended Symbol and being treated as a “C” or a “B” or an “A”) was a “C.”

In an embodiment in which a Blended Symbol functioning as all of the symbols which the Blended Symbol functions as (e.g., “A” and “B” and “C” for purposes of the example being illustrated in FIG. 6C), step 510 may comprise evaluating each active payline by inserting into the payline each of the symbols the Blended Symbol functions as. Thus, returning again to the hypothetical payline along symbol positions 611, 613, 615, 617 and 619 of FIG. 6C, applying the Blended Symbols to this payline would result in the following outcome: B A B C A B C A B-C-E-E. Such a combination or super symbol functionality of a Blended Symbol may be more desirable in embodiments in which the regular symbols being so combined are special symbols (e.g., character symbols) or symbols of the same type, which, when combined cause the symbols being combined to be treated as an augmented symbol or symbol which corresponds to a special functionality or ability. For example, assuming three “A” symbols are combined (e.g., the Blended Symbol is an “A” symbol and is determined to function, based on an area of effect, with two additional “A” symbols) the Blended Symbol may be considered to be an A³.

In some embodiments, a Blended Symbol (whether it functions as a combination of regular symbols, is substitutable for any one of the plurality of symbols which it functions as, or otherwise) may, once designated as such, correspond to a special functionality or ability. For example, a Blended Symbol may be locked into its symbol position for at least one additional game event, cause a payout of the payline to be multiplied, cause a bonus round to be triggered, etc.

Of course, many variations from the example illustrated above are contemplated. For example, in one embodiment not every symbol in each blended symbol position is determined to be a Blended Symbol. In one embodiment a first blended symbol position is selected for causing a Blended Symbol, such that the regular symbol in this particular blended symbol position is designated as a Blended Symbol position and at least one second symbol position (e.g., a single or a plurality (such as the remainder) of the blended symbol positions which are different from the first symbol position) are determined to comprise the area of effect for the Blended Symbol. In such an embodiment, the regular symbols appearing in the symbol positions comprising the area of effect are not determined to be Blended Symbols. Only a Blended Symbol is designated, the regular symbols appearing in the remaining symbol positions comprising the area of effect remain regular symbols and are used merely to determine what symbols the Blended Symbol is to function as (e.g., be substitutable for) in a determination of a result for the current game event.

Outputting or representing to a player which regular symbols a Blended Symbol functions as (e.g., is substitutable for) may be done in a variety of manners. In one embodiment, the regular symbols for which the Blended Symbol functions as may be individually represented in the symbol position of the Blended Symbol in some kind of blended graphic or depiction (e.g., as illustrated in the blended symbol positions of FIG. 6C). In another embodiment, different graphical depictions may be used to represent different possible sets of symbols for which a Blended Symbol functions as (e.g., is substitutable for). For example, Blended Symbol graphic X may be used to represent a Blended Symbol which functions as symbols “A”, “B” and “C”, Blended Symbol graphic Y may be used to represent a Blended Symbol which functions as symbols “A”, “D” and “E”, Blended Symbol graphic Z may be used to represent a Blended Symbol which functions as symbols “B”, “C” and “D” and so on.

In yet another embodiment, the symbol position of a Blended Symbol may step or cycle through a graphical representation of each regular symbol which the Blended Symbol functions as (e.g., is substitutable for), such that the symbol position in which the Blended Symbol is placed only shows one of the regular symbols which the Blended Symbol functions as at a given time. For example, the change the regular symbol shown in the symbol position every 1-2 seconds on an on-going basis. Such an embodiment is illustrated in FIGS. 7A-7C. The game interface illustrated in FIGS. 7A-7C is the same as that illustrated in FIGS. 6A-6C. It may be assumed that the embodiment of process 500 (FIG. 5) was utilized to identify blended symbol positions, determine that each regular symbol appearing in these blended symbol positions is a Blended Symbol and substitutable for every other Blended Symbol and that the same regular symbols were placed into blended symbol positions 701, 703, 705, 713 and 715 as were placed into corresponding blended symbol positions 601, 603, 605, 613 and 615 of FIG. 6B. However, as an alternate variation on how to represent a Blended Symbol (and in particular to represent or output to a player which regular symbols a Blended Symbol is substitutable for) FIGS. 7A-7C illustrate a cycling-through over time of the regular symbols which the Blended Symbol functions as. For example, FIG. 7A shows in each of the symbol positions 701, 703, 705, 713 and 715 the symbol “A” at time X, FIG. 7B shows in each of these symbol positions the symbol “B” at time (X+Y) and FIG. 7C shows in each of these symbol positions the symbol “C” at time (X+2Y), where Y may comprise a small increment of time such as 1-3 seconds, to show that the Blended Symbols in these symbol positions function as (e.g., are substitutable for) the symbols “A”, “B” and/or “C.”

In one embodiment, the area of effect and/or blended symbol positions could be modified (e.g., increase or expand) after an initial determination of such. In accordance with some embodiments, as an area of effect expands, the functionality of the corresponding Blended Symbol(s) may likewise increase, expand or be modified (e.g., the Blended Symbol(s) may become substitutable for a greater number of regular symbols). For example, if the area of effect corresponding to a Blended Symbol expands to include additional symbol positions which include regular symbols different from those the Blended Symbols are already substitutable for, the Blended Symbol may begin to function as the regular symbols in these additional symbol positions. Such an expanding area of effect is illustrated in the embodiment of FIGS. 8A-8C.

Turning now to FIGS. 8A-8C, these figures illustrate how an area of effect corresponding to one or more Blended Symbols may be expanded over the course of a game event or session, thus modifying the functionality of the one or more Blended Symbols. Whether a modification (e.g., expansion) of an area of effect is triggered may, in some embodiments, be based upon whether any winning combinations of symbols have been created (e.g., as a result of a Blended Symbol being applied to determine a result of a game event). In another embodiment, a special game mechanic or rule defines how an area of effect will be modified (e.g., how much the area of effect will expand and/or to which symbol positions it will expand to) over the course of a game event or session, for a cascade of an original spin or otherwise.

FIG. 8A illustrates a first set of symbol positions as defining an area of effect for a Blended Symbol: symbol positions 801, 803, 805, 813 and 815. FIG. 8A continues with the example of FIGS. 6B and 6C; the symbol positions defining an area of effect and the regular symbols which the Blended Symbols placed in these symbol positions (symbols A, B and/or C) correspond, for purposes of simplicity, to the area of effect shown in FIGS. 6B and 6C (symbol position 801 corresponds to symbol position 601, symbol position 803 corresponds to symbol position 603, etc.). However, in the embodiment of FIGS. 8A-8C, this area of effect may, subsequent to an initial determination of the area of effect, expand to include additional symbol positions. As a non-limiting example of such an expansion and continuing from the example symbols placed in the symbol positions of FIG. 6C, FIG. 8B illustrates that the area of effect has expanded to symbol position 817. Since symbol position 617 of FIG. 6C, which corresponds to symbol position 817 of FIG. 8B, has a regular symbol “E” placed therein. Thus, in accordance with some embodiments and as illustrated in FIG. 8C, the Blended Symbols in this example now function as symbol “E” in addition to the regular symbols “A”, “B” and “C.” This additional functionality is illustrated in symbol position 817 of FIG. 8C, which indicates that the Blended Symbol of this symbol position functions as “A, B, C and/or E.”

In some embodiments, when a regular symbol is determined to be a Blended Symbol (e.g., it is randomly designated as a Blended Symbol for a particular spin or appears in a symbol position of a game interface which has been determined to be a blended symbol position), the regular symbol is replaced by, or modified or turned into, the Blended Symbol. “Replacing” a regular symbol with a Blended Symbol or “modifying” or “turning” a regular symbol into a Blended Symbol may comprise any manner or methodology for (i) causing a symbol position in which a Blended Symbol appears or could appear to indicate that it is associated with a functionality which causes a symbol appearing therein to function as (e.g., be substitutable for) a plurality of regular symbols (e.g., the symbols in the symbol positions comprising the area of effect corresponding to the symbol position in which the Blended Symbol appears); or (ii) causing a regular symbol itself to function as (e.g., be substitutable for) the determined set of regular symbols, the set being greater than one. The usage of the term “replacing”, “modifying” or “turning into” in such a context throughout the present description is not intended to limit the scope of the embodiments to a traditional “replacement” in which the regular symbol is removed from the symbol position and a different special symbol or representation is placed in the symbol position in its stead. In some embodiments, for example, “replacing” a regular symbol with a Blended Symbol may comprise superimposing a semi-transparent image of a graphic representing a Blended Symbol on the regular symbol, outputting an indication that the symbol in the Blended Symbol position functions as (e.g., is substitutable for) a plurality of regular symbols without removing the regular symbol which appears in that position or any other manner of designating a symbol or symbol position as corresponding to the functionality of a symbol which may function as (e.g., be substitutable for, or count as) one or more of a plurality of regular symbols (e.g., any one of a plurality of regular symbols in the game which are a subset of all available symbols in the game), such as by highlighting, shading, animating or otherwise altering the symbol position and/or regular symbol. In one embodiment, indicating that a regular symbol is now considered a Blended Symbol and/or that a symbol position is a Blended Symbol position may comprise outputting an indication of which particular symbols the symbol in that position function as (e.g., is substitutable for), such as illustrated in FIGS. 6A-6C, 7A-7C and 8A-8C.

In accordance with some embodiments, once at least one regular symbol of an outcome is designated as a Blended Symbol, the paylines of the game are re-evaluated for the current spin to determine whether any new or additional winning combinations have been created along the paylines due to the functionality of the Blended Symbol. In some embodiments, only the paylines the player bet on when initiating the spin (i.e., the “active” paylines for the spin) may be evaluated in the re-evaluating step after the designation of the regular symbol(s) as Blended Symbol(s). In other embodiments, all paylines may be evaluated for winning combinations after the designating a Blended Symbol for a game event. In some embodiments, a step of designating at least one regular symbol as a Blended Symbol may be iterative such that, after the re-evaluating of the paylines, it is again determined whether any additional Blended Symbol(s) have been designated and/or whether the Blended Symbol(s) (whether they be the originally designated Blended Symbol(s) or additional ones) function as (e.g., are substitutable for any additional regular symbols (e.g., due to an expansion of an area of effect) and, if so, the re-evaluating of the paylines is again performed. In other embodiments, a Blended Symbol is only maintained for the spin in which it was designated as such and/or only a single evaluation of the paylines by applying the functionality of the Blended Symbol(s) is performed.

In some embodiments, multiple areas of effect may function to create interesting combinations or results. For example, a game may use two different areas of effect, which may be differentiated in some manner such as by use of different colors in the game interface (blue and red for example). Each distinct area of effect may correspond to a distinct Blended Symbol (e.g., a first Blended Symbol corresponding to the blue area of effect may be substitutable for all regular symbols which are output in the symbol positions comprising the blue area of effect while a second Blended Symbol corresponding to a red area of effect may be substitutable for all regular symbols output in symbol positions within the red area of effect). Use of a plurality of areas of effect may, in some embodiments, be used differently. For example, in on embodiment, a red area of effect is 1 or more destination symbols while a blue area of effect defines all the symbols that will combine into the destination symbol positions.

In accordance with some embodiments, an area of effect may be defined as all the symbol positions of a particular reel (or all the visible symbol positions of a particular reel, as visible to a player of the game viewing the game interface). In such an embodiment, all regular symbols appearing in the visible symbol positions of a given reel may be designated as Blended Symbols and be substitutable for one another (e.g., for a particular spin, series of spins or for all spins in the game). For example, in one embodiment an area of effect comprising a reel may potentially have a different combination of symbols for each outcome and thus the symbols for which the Blended Symbols of the reel may function as (e.g., are substitutable for) may change from spin to spin, based on the particular outcome of the spin.

In one embodiment, a particular symbol position (e.g., in a reeled slot machine game) may be designated as a “catch” symbol position which functions to “catch” regular symbols which cascade or are otherwise removed from the game interface (e.g., such as in a cascade feature of a reeled slot machine game). In such embodiments, the “catch” position may function as a blended symbol position such that the symbol in the catch position may function as (e.g., be substitutable for) any symbol which is caught, moved to or otherwise caused to appear in that symbol position (even temporarily as a transient symbol) as a result of some secondary feature of the game. For example, the symbols for which the symbol in the “catch” position functions as (e.g., is substitutable for) may be used as a Blended Symbol for evaluation in the next cascade evaluation. In one embodiment, such a “catch” symbol position may function to draw in cascading symbols from nearby (e.g., adjacent) symbol positions. In one embodiment, a “catch” position may function to draw in cascading symbols from a limited direction (e.g. only the symbols from the symbol positions above the “catch” position). In such an embodiment, an area of effect need not be defined since it is a secondary effect (e.g., a cascade feature being triggered) that determines which regular symbols the Blended Symbol in the “catch” position function as (e.g., is substitutable for).

In some embodiments, one or more limitations may be set for practical reasons or as part of a gameplay mechanic. For example, limits (e.g., a maximum) on the size (e.g., number of symbol positions) comprising an area of effect and/or the number of regular symbols which a Blended Symbol functions as (e.g., is substitutable for) may be set. For example: in the cascading “catch” embodiment once a symbol position has “caught” 3 other regular symbols it can no longer catch any more and therefore the maximum number of regular symbols which the Blended Symbol of the “catch” position may function as (e.g., is substitutable for) may be 4 (the 3 which are caught plus the regular symbol appearing in the “catch” position as a primary result of the game). In one embodiment, such a “catch” feature may end once the 3^{rd} regular symbol is caught; the Blended Symbol of the “catch” position may persist until a limit is reached.

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

### Rules of Interpretation

The present disclosure is neither a literal description of all embodiments nor a listing of features of the invention that must be present in all embodiments.

The Title (set forth at the beginning of the first page of this disclosure) is not to be taken as limiting in any way as the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “and/or”, when such term is used to modify a list of things or possibilities (such as an enumerated list of possibilities) means that any combination of one or more of the things or possibilities is intended, such that while in some embodiments any single one of the things or possibilities may be sufficient in other embodiments two or more (or even each of) the things or possibilities in the list may be preferred, unless expressly specified otherwise. Thus for example, a list of “a, b and/or c” means that any of the following interpretations would be appropriate: (i) each of “a”, “b” and “c”; (ii) “a” and “b”; (iii) “a” and “c”; (iv) “b” and “c”; (v) only “a”; (vi) only “b”; and (vii) only “c.”

The term “plurality” means “two or more”, unless expressly specified otherwise.

The term “herein” means “in the present disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, component or article is described herein, more than one device, component or article (whether or not they cooperate) may alternatively be used in place of the single device, component or article that is described. Accordingly, the functionality that is described as being possessed by a device may alternatively be possessed by more than one device, component or article (whether or not they cooperate).

Similarly, where more than one device, component or article is described herein (whether or not they cooperate), a single device, component or article may alternatively be used in place of the more than one device, component or article that is described. For example, a plurality of computer-based devices may be substituted with a single computer-based device. Accordingly, the various functionality that is described as being possessed by more than one device, component or article may alternatively be possessed by a single device, component or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this disclosure are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining, recognizing, and the like.

A “display” as that term is used herein is an area that conveys information to a viewer. The information may be dynamic, in which case, an LCD, LED, CRT, Digital Light Processing (DLP), rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as Standard Definition Television (SDTV), Enhanced Definition TV (EDTV), High Definition TV (HDTV), or the like. The information may likewise be static, in which case, painted glass may be used to form the display. Note that static information may be presented on a display capable of displaying dynamic information if desired. Some displays may be interactive and may include touch screen features or associated keypads as is well understood.

The present disclosure may refer to a “control system” or program. A control system or program, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium or an article of manufacture, which may be non-transitory in nature). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, Central Processing Unit (CPU) devices, computing devices, microcontrollers, digital signal processors, or like devices. Exemplary processors are the INTEL PENTIUM or AMD ATHLON processors.

The term “computer-readable medium” refers to any statutory medium that participates in providing data (e.g., instructions) that may be read by a computer, a processor or a like device. Such a medium may take many forms, including but not limited to non-volatile media, volatile media, and specific statutory types of transmission media. Non-volatile media include, for example, optical or magnetic disks and other persistent memory. Volatile media include DRAM, which typically constitutes the main memory. Statutory types of transmission media include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable memory”, “article of manufacture” and/or “tangible media” specifically exclude signals, waves, and wave forms or other intangible or non-transitory media that may nevertheless be readable by a computer.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described herein may be implemented by a control system and/or the instructions of the software may be designed to carry out the processes of the present invention.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, LAN, WAN or Ethernet (or IEEE 802.3), Token Ring, or via any appropriate communications means or combination of communications means. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software. Accordingly, a description of a process likewise describes at least one apparatus for performing the process, and likewise describes at least one computer-readable medium and/or memory for performing the process. The apparatus that performs the process can include components and devices (e.g., a processor, input and output devices) appropriate to perform the process. A computer-readable medium can store program elements appropriate to perform the method.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

What is claimed is:

1. A gaming system for implementing a game mechanic of an electronic game,
the gaming system comprising:
a processor;
a display device;
a memory storing a program,
the processor being operable to communicate with a random number generator in order to determine a random number for use in determining an outcome for a game event of the electronic game, and the processor being further operable with the program to perform a method, the method comprising:
(a) providing a game interface comprising a plurality of symbol positions, the plurality of symbol positions arranged in a plurality of rows and a plurality of columns, wherein the game interface further comprises a plurality of paylines, each payline comprising a plurality of symbol positions such that a winning outcome comprises a predetermined combination of symbols being displayed in the symbol positions comprising a payline of the plurality of paylines upon a resolution of a game event;
(b) receiving a request to determine a result of a game event of the game;
(c) determining, in response to the request and based on an output of the random number generator, a plurality of regular symbols for the game event;
(d) populating the plurality of regular symbols into the symbol positions of the game interface by placing, into each symbol position, one regular symbol of the plurality of regular symbols determined for the game event;
(e) identifying that a first regular symbol of the plurality of regular symbols is to be designated as a first blended symbol in determining the result of the game event, wherein a blended symbol comprises a symbol which functions as at least two regular symbols of the game in determining results for game events of the game, the at least two regular symbols which the blended symbol functions as being determined based on the plurality of regular symbols determined for the game event in which the blended symbol is to be applied;
(f) determining at least two regular symbols which the first blended symbol is to function as in determining the result of the game event by determining at least one second regular symbol of the plurality of symbols, thereby determining the functionality of the first blended symbol for a current game event;
(g) evaluating each active payline of the game event to determine the result of the game event by applying the functionality of the first blended symbol; and
(h) for each winning outcome comprising the result, causing a corresponding payout to be provided to a player associated with the game event.

2. The gaming system of claim 1, wherein each column of the plurality of columns in the game interface represents a reel of a slot-machine type game.

3. The gaming system of claim 1, wherein the first blended symbol functioning as the at least two symbols comprises the first blended symbol being substitutable for any regular symbol of the at least two symbols, in the alternative, for purposes of determining a result of the game event.

4. The gaming system of claim 1, wherein the first blended symbol functioning as at least two symbols comprises the first blended symbol being treated as a combination of each of the at least two symbols, for purposes of determining a result of the game event.

5. The gaming system of claim 4, wherein each of the at least two symbols are of the same type and the first blended symbol functioning as the at least two regular symbols comprises a special characteristic to be attributed to the at least two regular symbols.

6. The gaming system of claim 4, wherein the special characteristic comprises a locking in of the first blended symbol into a symbol position of the game interface for at least one additional game event.

7. The gaming system of claim 1, wherein one of the at least two regular symbols which the first blended symbol functions as is the first regular symbol which was designated as the first blended symbol.

8. The gaming system of claim 1, wherein determining the at least one second regular symbol comprises:
determining an area of effect corresponding to the first blended symbol, the area of effect comprising a plurality of symbol positions of the game interface which is less than all of the symbol positions of the game interface and which includes at least one symbol position different from a symbol position in which the first regular symbol is located; and
determining, for each symbol positing comprising the area of effect, which regular symbol is displayed in such symbol position, thereby identifying possible at least one second symbols for the first blended symbol; and
selecting, from the possible at least one second symbols, the at least one second symbol which the first blended symbol is to function as for the game event.

9. The gaming system of claim 8, wherein the area of effect includes the symbol position in which the first regular symbol is located.

10. The gaming system of claim 8, wherein the method which the processor is operable with the program to perform further comprises:
determining that the first regular symbol is to be the first blended symbol by determining that the first regular symbol is in a symbol position which is part of the area of effect.

11. The gaming system of claim 8, wherein determining the area of effect comprises determining the area of effect based on a pseudo-random process.

12. The gaming system of claim 8, wherein determining the area of effect comprises determining the area of effect based on a rule of the electronic game.

13. The gaming system of claim 1, wherein determining the area of effect comprises determining a pre-determined positional relationship of regular symbols within the symbol positions of the game interface and determining the area of effect to include at least a subset of the symbol positions in which the regular symbols arranged in the pre-determined positional relationship.

14. The gaming system of claim 13, wherein determining the area of effect comprises determining a pre-determined positional relationship of regular symbols which are of a same type.

15. The gaming system of claim 1, wherein the method which the processor is operable with the program to perform further comprises:
identifying, prior to steps (e) and (f) and without taking into account any symbols which the first blended symbol is to function as, an initial result for the game event based on the plurality of regular symbols determined for the game event;
causing, if the initial result corresponds to at least one award, the at least one award to be provided to the player associated with the game event;
and wherein step (g), after steps (e) and (f) are performed, comprises:
re-evaluating the each active payline of the game event to determine a modified result of the game event to determine whether the modified result qualifies the player for any additional awards; and
causing any additional awards to be provided to the player.

16. The gaming system of claim 1, wherein determining that the first regular symbol is to function as the first blended symbol comprises determining that the first regular symbol qualifies to be replaced with the first blended symbol in the game interface.

17. The gaming system of claim 1, wherein determining that the first regular symbol is to be designated as the first blended symbol comprises selecting the first regular symbol via an algorithm for selecting, for a game event, at least one regular symbol comprising an outcome of the game event to be designated as a blended symbol.

18. The gaming system of claim 1, wherein the method the processor is operable with the program to perform further comprises:
selecting, for the game event, a position of the plurality of symbol positions to be a blended symbol position, and
wherein determining that the first regular symbol is to be designated as the first blended symbol comprises determining that the first regular symbol has been placed into the blended symbol position.

19. The gaming system of claim 1, wherein determining that the first regular symbol is to be designated as the first blended symbol is performed prior to displaying to the player the first regular symbol in a first symbol position of the plurality of symbol positions.

20. A non-transitory computer-readable medium storing instructions, which instructions when performed by a processor cause the processor to perform a method, the method comprising:
(a) providing a game interface comprising a plurality of symbol positions, the plurality of symbol positions arranged in a plurality of rows and a plurality of columns, wherein the game interface further comprises a plurality of paylines, each payline comprising a plurality of symbol positions such that a winning outcome comprises a predetermined combination of symbols being displayed in the symbol positions comprising a payline of the plurality of paylines upon a resolution of a game event;
(b) receiving a request to determine a result of a game event of the game;
(c) determining, in response to the request and based on an output of the random number generator with which the processor is operable to communicate, a plurality of regular symbols for the game event;
(d) populating the plurality of regular symbols into the symbol positions of the game interface by placing, into each symbol position, one regular symbol of the plurality of regular symbols determined for the game event;
(e) identifying that a first regular symbol of the plurality of regular symbols is to be designated as a first blended symbol in determining the result of the game event, wherein a blended symbol comprises a symbol which functions as at least two regular symbols of the game in determining results for game events of the game, the at least two regular symbols which the blended symbol functions as being determined based on the plurality of regular symbols determined for the game event in which the blended symbol is to be applied;
(f) determining at least two regular symbols which the first blended symbol is to function as in determining the result of the game event by determining at least one second regular symbol of the plurality of symbols, thereby determining the functionality of the first blended symbol for a current game event;
(g) evaluating each active payline of the game event to determine the result of the game event by applying the functionality of the first blended symbol; and
(h) for each winning outcome comprising the result, causing a corresponding payout to be provided to a player associated with the game event.
